(19) United States
(12) Patent Application Publication
(10) Pub. No.: US 2017/0336282 A1
(43) Pub. Date: Nov. 23, 2017

(54) SPHEROIDAL MIRROR REFLECTIVITY MEASURING APPARATUS FOR EXTREME ULTRAVIOLET LIGHT

(71) Applicants: The University of Tokyo, Tokyo (JP); GIGAPHOTON INC., Tochigi (JP)

(72) Inventors: Yohei KOBAYASHI, Tokyo (JP); Hakaru MIZOGUCHI, Tochigi (JP); Junichi FUJIMOTO, Tochigi (JP); Katsunori ISOMOTO, Tochigi (JP); Osamu WAKABAYASHI, Tochigi (JP); Georg SOUMAGNE, Tochigi (JP)

(73) Assignees: The University of Tokyo, Tokyo (JP); GIGAPHOTON INC., Tochigi (JP)

(21) Appl. No.: 15/672,961

(22) Filed: Aug. 9, 2017

Related U.S. Application Data
(63) Continuation of application No. PCT/JP2015/058511, filed on Mar. 20, 2015.

(51) Int. Cl. G01M 11/00; G01N 21/55

(52) U.S. Cl. CPC G01M 11/005; G01N 21/55; G01N 2201/0697; G01N 2201/06113

(57) ABSTRACT

A spheroidal mirror reflectivity measuring apparatus for extreme ultraviolet light may include an extreme ultraviolet light source, an optical system, and a first photosensor. The extreme ultraviolet light source may be configured to output extreme ultraviolet light to a spheroidal mirror that includes a spheroidal reflection surface. The optical system may be configured to allow the extreme ultraviolet light to travel to the spheroidal reflection surface via a first focal position of the spheroidal mirror. The first photosensor may be provided at a second focal position of the spheroidal mirror, and may be configured to detect the extreme ultraviolet light that has passed through the first focal position and then has been reflected by the spheroidal reflection surface.

### CROSS REFERENCE TO RELATED APPLICATIONS

The present application is a continuation application of International Application No. PCT/JP2015/058511 filed on Mar. 20, 2015. The content of the application is incorporated herein by reference in its entirety.

### BACKGROUND

### 1. Technical Field

The present disclosure relates to a spheroidal mirror reflectivity measuring apparatus for extreme ultraviolet light.

### 2. Related Art

In recent years, miniaturization of a transfer pattern of an optical lithography in a semiconductor process is drastically progressing with the development in fining of the semiconductor process. In the next generation, microfabrication on the order of 70 nm to 45 nm, and further microfabrication on the order of 32 nm or less are bound to be required. To meet such requirement for the microfabrication on the order of, for example, 32 nm or less, development is anticipated of an exposure apparatus that includes a combination of a reduced projection reflective optics and an extreme ultraviolet light generating apparatus that generates extreme ultraviolet (EUV) light with a wavelength of about 13 nm. For example, reference is made in Japanese Unexamined Patent Application Publication No. 2013-195535. U.S. Pat. No. 8,649,086, U.S. Pat. No. 8,704,198, and J. Tummler, H. Blume, G. Brandt, J. Eden, B. Meyer, H. Scherr, F. Scholz, F. Scholze, G. Ulm “Characterization of the PTB EUV reflectometry facility for large EUVL optical components”, Proc. SPIE 5037, 265-273 (2003).

As the EUV light generating apparatus, there have been proposed three kinds of apparatuses, a laser produced plasma (LPP) apparatus using plasma generated by application of laser light to a target substance, a discharge produced plasma (DPP) apparatus using plasma generated by discharge, and a synchrotron radiation (SR) apparatus using orbital radiation light.

### SUMMARY

A spheroidal mirror reflectivity measuring apparatus for extreme ultraviolet light according to an aspect of the present disclosure may include an extreme ultraviolet light source, an optical system, and a first photosensor. The extreme ultraviolet light source may be configured to output extreme ultraviolet light to a spheroidal mirror that includes a spheroidal reflection surface. The optical system may be configured to allow the extreme ultraviolet light to travel to the spheroidal reflection surface via a first focal position of the spheroidal mirror. The first photosensor may be provided at a second focal position of the spheroidal mirror, and may be configured to detect the extreme ultraviolet light that has passed through the first focal position and then has been reflected by the spheroidal reflection surface.

### BRIEF DESCRIPTION OF THE DRAWINGS

Some example embodiments of the present disclosure are described below as mere examples with reference to the accompanying drawings.

FIG. 1 schematically illustrates a configuration example of an exemplary LPP EUV light generating system.

FIG. 2 schematically illustrates a configuration example of a reflectivity measuring apparatus according to a first embodiment.

FIG. 3 schematically illustrates a configuration example of a coherent EUV light source in the reflectivity measuring apparatus illustrated in FIG. 2.

FIG. 4 is a main flow chart illustrating an example of a flow of control by a measurement controller in the reflectivity measuring apparatus illustrated in FIG. 2.

FIG. 5 is a sub-flow chart illustrating details of a process in step S11 in the main flow chart illustrated in FIG. 4.

FIG. 6 schematically illustrates an example of a table including measurement condition parameters.

FIG. 7 is a sub-flow chart illustrating details of a process in step S12 in the main flow chart illustrated in FIG. 4.

FIG. 8 is a sub-flow chart illustrating details of a process in step S13 in the main flow chart illustrated in FIG. 4.

FIG. 9 is a sub-flow chart illustrating details of a process in step S15 in the main flow chart illustrated in FIG. 4.

FIG. 10 is a sub-flow chart illustrating a specific example of a process in step S55 in the sub-flow chart illustrated in FIG. 9.

FIG. 11 is a sub-flow chart illustrating another specific example of the process in the step S55 in the sub-flow chart illustrated in FIG. 9.

FIG. 12 schematically illustrates an example of a relationship between an incident angle θ of EUV light with respect to a movable mirror and reflectivity R.

FIG. 13 is a sub-flow chart illustrating details of a process in step S16 in the main flow chart illustrated in FIG. 4.

FIG. 14 schematically illustrates an example of a table where measurement results are written.

FIG. 15 is a sub-flow chart illustrating details of a process in step S20 in the main flow chart illustrated in FIG. 4.

FIG. 16 schematically illustrates an equation representing an elliptical shape.

FIG. 17 schematically illustrates parameters used to create a reflectivity map.

FIG. 18 schematically illustrates an example of the reflectivity map.

FIG. 19 schematically illustrates a configuration example of a coherent EUV light source in a reflectivity measuring apparatus according to a second embodiment.

FIG. 20 schematically illustrates a configuration example of a coherent EUV light source in a reflectivity measuring apparatus according to a third embodiment.

FIG. 21 schematically illustrates a modification example of a filter section in the coherent EUV light source.

FIG. 22 schematically illustrates a configuration example of a femtosecond laser unit in the coherent EUV light source.

FIG. 23 schematically illustrates a configuration example of a spectrometer in the coherent EUV light source.

FIG. 24 illustrates an example of a hardware environment of a controller.

### DETAILED DESCRIPTION

### <Contents>

### [1. Overview]

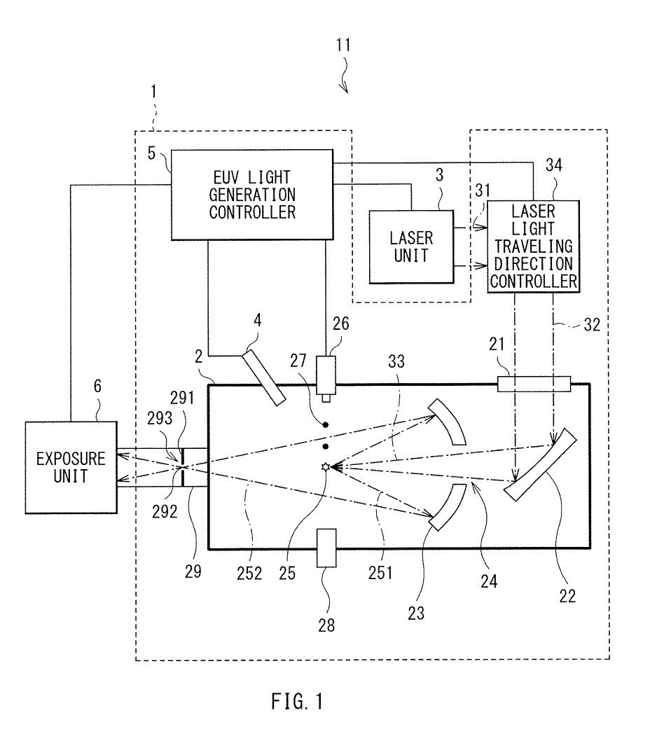

### [2. General Description of EUV Light Generating Apparatus] (FIG. 1)

2.1 Configuration

2.2 Operation

2.3 Issues

[3. First Embodiment] (Spheroidal mirror reflectivity measuring apparatus for EUV light that uses a coherent EUV light source)

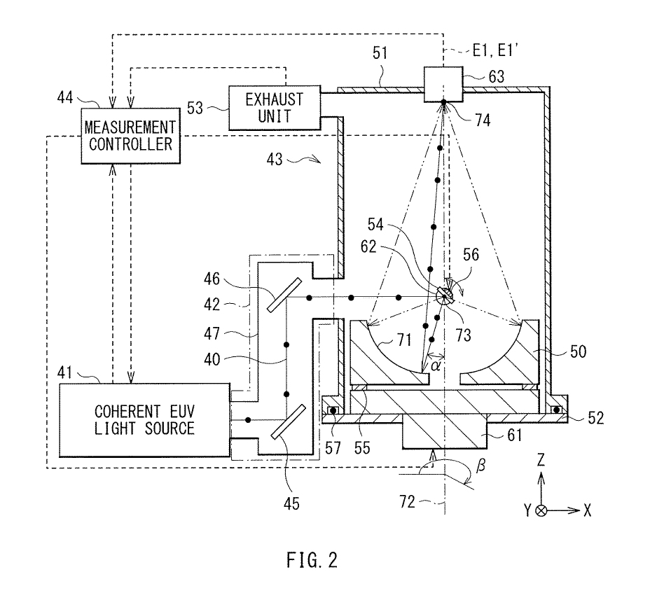

3.1 Reflectivity Measuring Apparatus
3.1.1 Configuration (FIG. 2)
3.1.2 Operation
3.1.3 Workings
3.1.4 Modification Examples

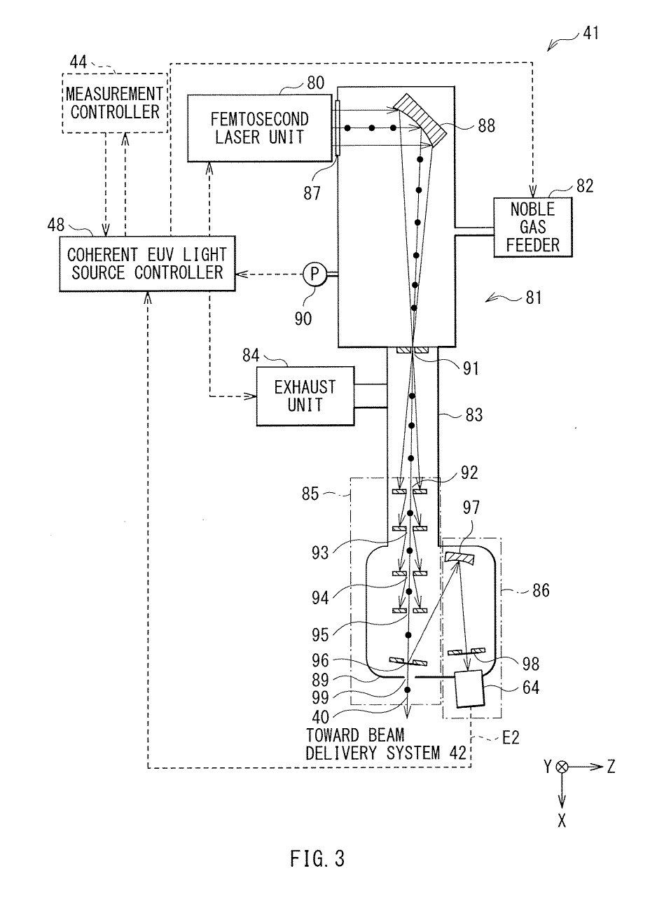

3.2 Coherent EUV Light Source
3.2.1 Configuration (FIG. 3)
3.2.2 Operation
3.2.3 Modification Examples

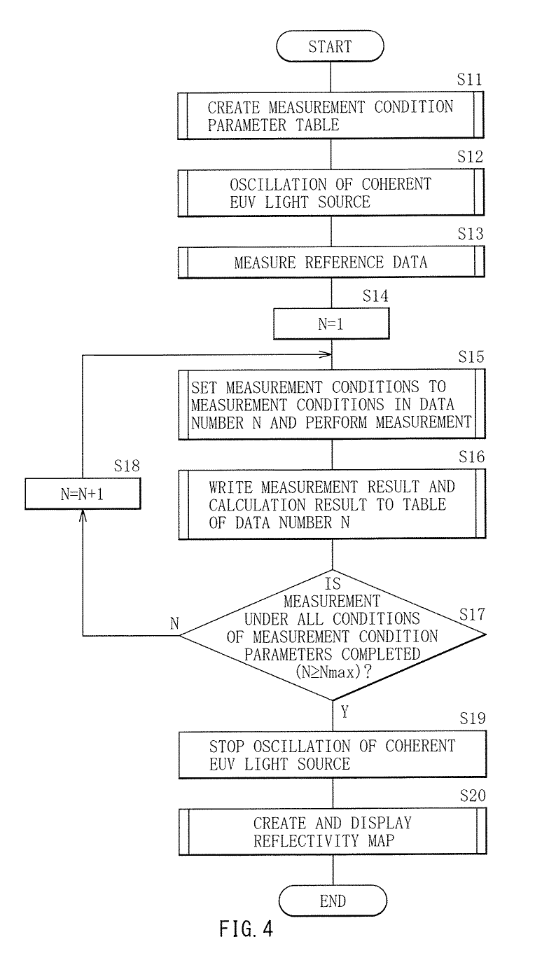

3.3 Specific Examples of Reflectivity Measurement (FIGS. 4 to 18)

[4. Second Embodiment] (Coherent EUV light source that controls polarization characteristics)

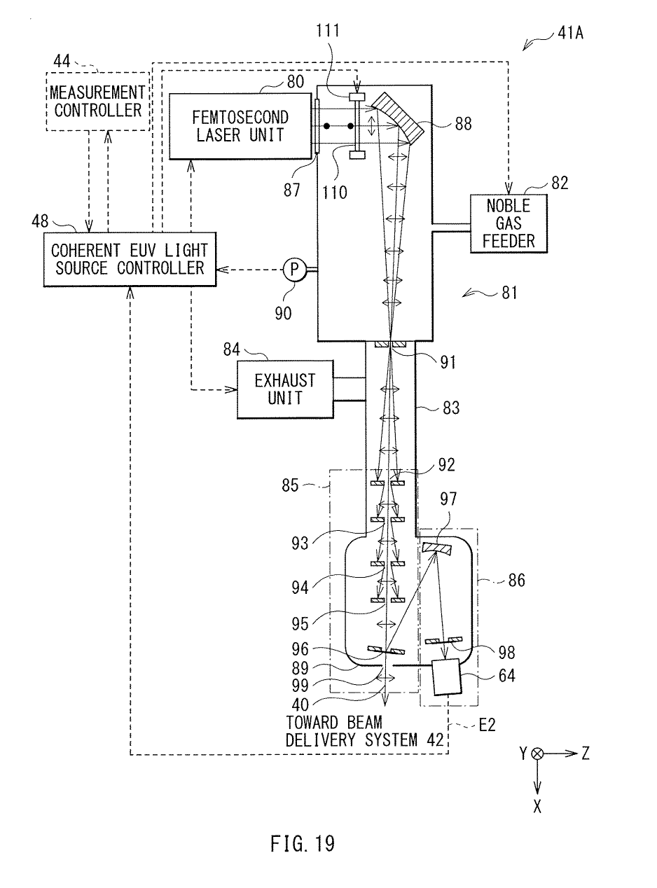

4.1 Configuration (FIG. 19)

4.2 Operation

4.3 Workings

4.4 Modification Examples

[5. Third Embodiment] (Coherent EUV light source that controls oscillation wavelength)

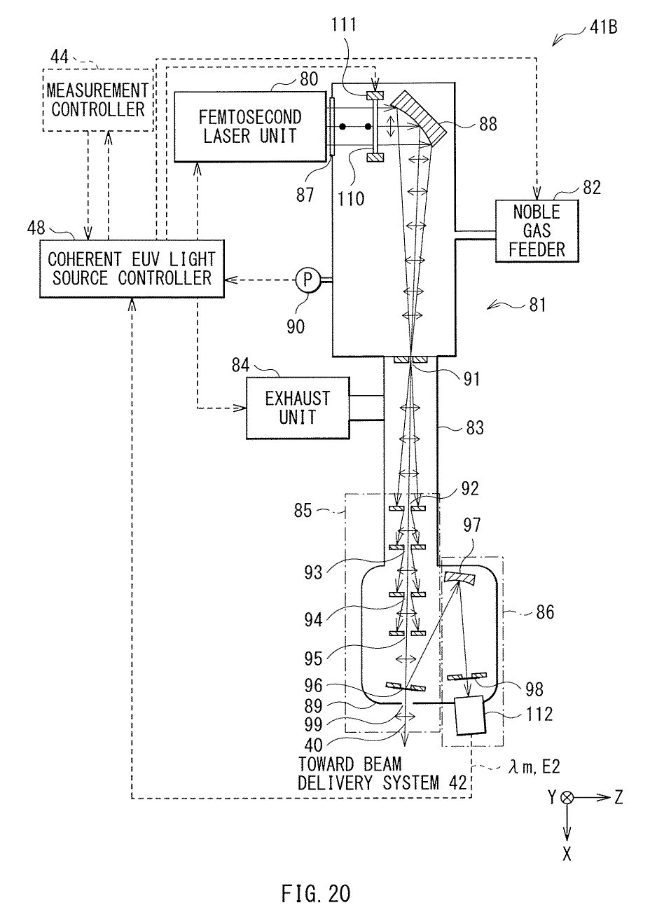

5.1 Configuration (FIG. 20)

5.2 Operation

5.3 Workings

5.4 Modification Examples

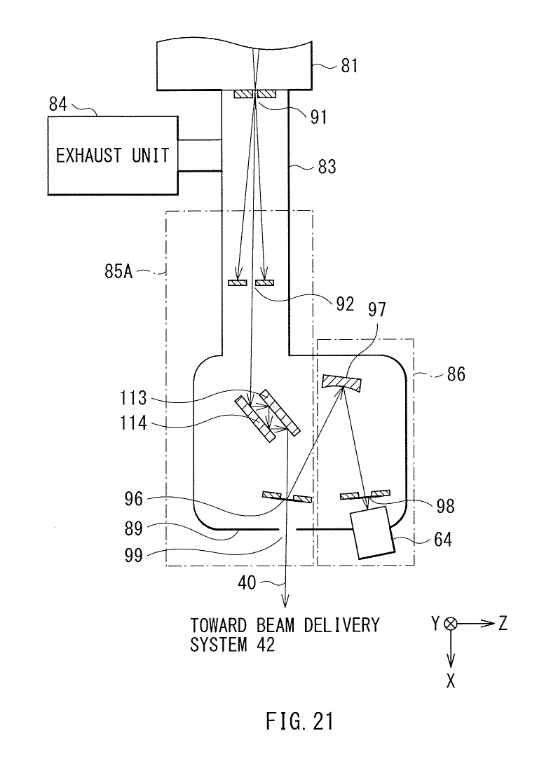

### [6. Variations of Filter Section] (FIG. 21)

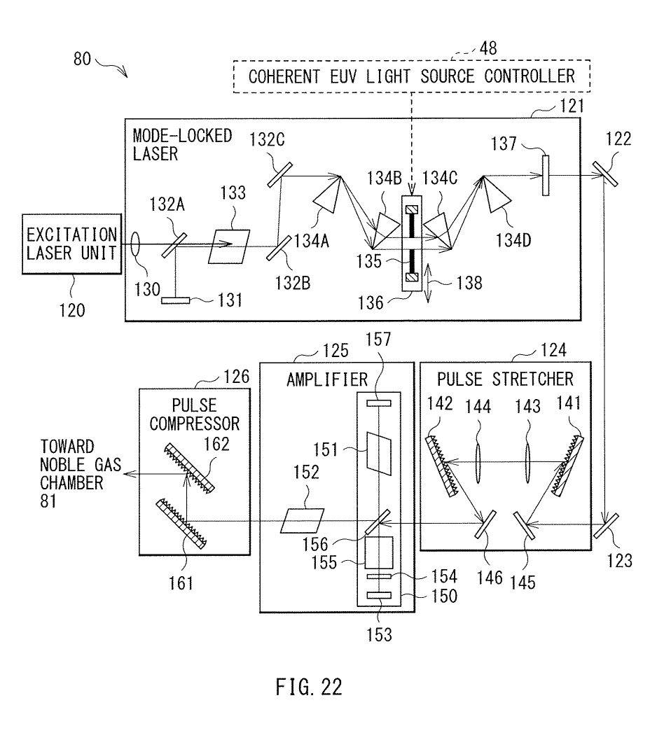

### [7. Femtosecond Laser Unit] (FIG. 22)

7.1 Configuration

7.2 Operation

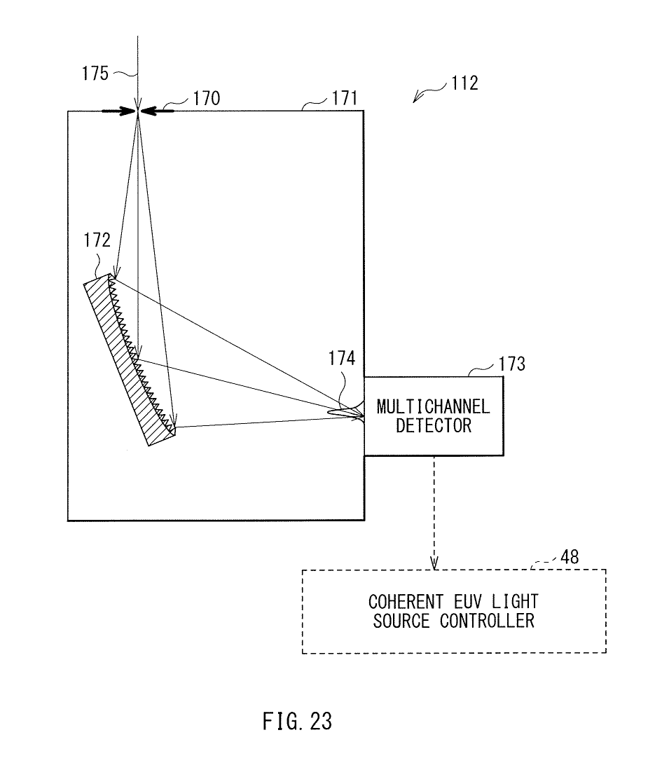

### [8. Spectrometer] (FIG. 23)

8.1 Configuration

8.2 Operation

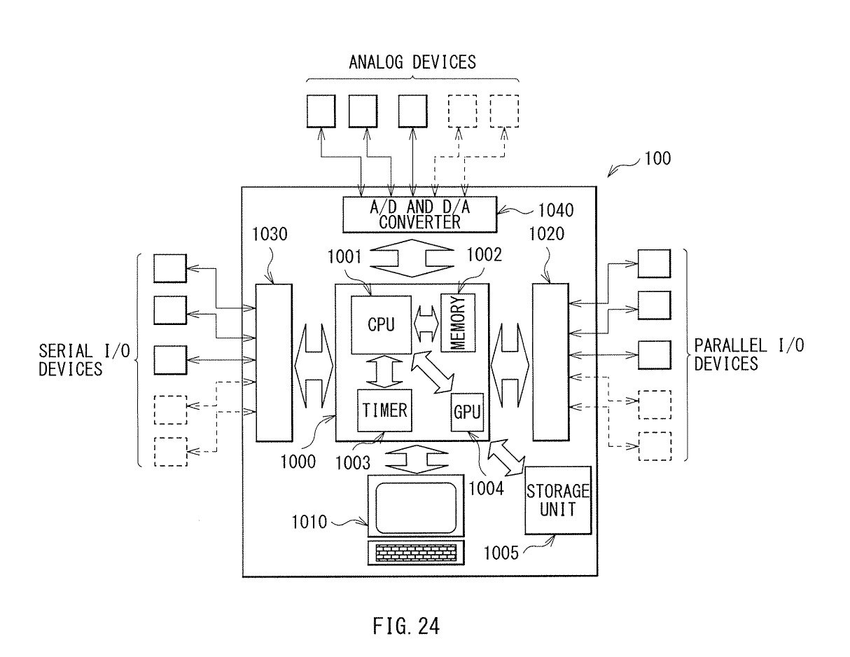

### [9. Hardware Environment of Controller] (FIG. 24)

### [10. Et Cetera]

In the following, some example embodiments of the present disclosure are described in detail with reference to the drawings. Example embodiments described below each illustrate one example of the present disclosure and are not intended to limit the contents of the present disclosure. Further, all of the configurations and operations described in each example embodiment are not necessarily essential for the configurations and operations of the present disclosure. Note that like components are denoted by like reference numerals, and redundant description thereof is omitted.

### 1. Overview

The present disclosure relates to a reflectivity measuring apparatus that measures, for example, reflectivity of a spheroidal mirror used as a light concentrating mirror for extreme ultraviolet (EUV) light in an EUV light generating apparatus.

### 2. General Description of EUV Light Generating Apparatus

### (2.1 Configuration)

FIG. 1 schematically illustrates a configuration of an exemplary laser produced plasma (LPP) EUV light generating system. An EUV light generating apparatus 1 may be used together with one or more laser units 3. In example embodiments disclosed in the present application, a system including the EUV light generating apparatus 1 and the laser unit 3 is referred to as an EUV light generating system 11. As illustrated in FIG. 1 and as described in detail below, the EUV light generating apparatus 1 may include a chamber 2 and, for example, a target feeder 26 serving as a target feeding unit. The chamber 2 may be sealable. The target feeder 26 may be so attached as to penetrate a wall of the chamber 2, for example. A material of a target substance to be supplied from the target feeder 26 may be tin, terbium, gadolinium, lithium, xenon, or any combination of two or more thereof without limitation.

The wall of the chamber 2 may be provided with one or more through holes. A window 21 may be provided at the through hole. Pulsed laser light 32 outputted from the laser unit 3 may pass through the window 21. For example, an EUV light concentrating mirror 23 including a spheroidal reflection surface may be provided inside the chamber 2. The EUV light concentrating mirror 23 may include a first focal point and a second focal point. A surface of the EUV light concentrating mirror 23 may be provided with a multilayer reflection film in which, for example, molybdenum and silicon are alternately stacked. For example, the EUV light concentrating mirror 23 may be preferably disposed so that the first focal point is located in a plasma generation region 25 or in the vicinity of the plasma generation region 25, and that the second focal point is located at an intermediate focus point (IF) 292. The intermediate focus point 292 may be a desired light concentration position defined by specifications of an exposure unit 6. The EUV light concentrating mirror 23 may be provided with a through hole 24 provided at a center part of the EUV light concentrating mirror 23 and through which pulsed laser light 33 may pass.

The EUV light generating apparatus 1 may include an EUV light generation controller 5. The EUV light generation controller 5 may include a target sensor 4, etc. The target sensor 4 may detect one or more of presence, trajectory, position, and speed of a target 27. The target sensor 4 may include an imaging function.

The EUV light generating apparatus 1 may further include a connection section 29 that allows the inside of the chamber 2 to be in communication with the inside of the exposure unit 6. A wall 291 provided with an aperture 293 may be provided inside the connection section 29. The wall 291 may be disposed so that the aperture 293 is located at the second focal point of the EUV light concentrating mirror 23.

The EUV light generating apparatus 1 may further include, for example, a laser light traveling direction controller 34, a laser light concentrating mirror 22, a target collector 28, etc. The target collector 28 may collect the target 27. The laser light traveling direction controller 34 may include, in order to control a traveling direction of laser light, an optical device that defines the traveling direction of the laser light and an actuator that adjusts position, attitude, etc. of the optical device.

### (2.2 Operation)

With reference to FIG. 1, pulsed laser light 31 outputted from the laser unit 3 may travel through the laser light traveling direction controller 34. The pulsed laser light 31 that has passed through the laser light traveling direction controller 34 may enter, as the pulsed laser light 32, the chamber 2 after passing through the window 21. The pulsed laser light 32 may travel inside the chamber 2 along one or more laser light paths, and then may be reflected by the laser light concentrating mirror 22. The pulsed laser light 32 reflected by the laser light concentrating mirror 22 may be applied, as the pulsed laser light 33, to one or more targets 27.

The target feeder 26 may be configured to output the target 27 to the plasma generation region 25 inside the chamber 2. The target 27 may be irradiated with one or more pulses included in the pulsed laser light 33. The target 27 irradiated with the pulsed laser light may be turned into a plasma, and EUV light 251 may be radiated together with radiation light from the plasma. The EUV light 251 may be reflected and concentrated by the EUV light concentrating mirror 23. EUV light 252 reflected by the EUV light concentrating mirror 23 may travel through the intermediate focus point 292. The EUV light 252 having passed through the intermediate focus point 292 may be outputted to the exposure unit 6. Note that a plurality of pulses included in the pulsed laser light 33 may be applied to one target 27.

The EUV light generation controller 5 may be configured to manage a control of the EUV light generating system 11 as a whole. The EUV light generation controller 5 may be configured to process, for example, data of an image of the target 27 taken by the target sensor 4. For example, the EUV light generation controller 5 may be configured to control one or both of an output timing of the target 27 and an output direction of the target 27.

For example, the EUV light generation controller 5 may be configured to control one or more of an oscillation timing of the laser unit 3, the traveling direction of the pulsed laser light 32, and a concentration position of the pulsed laser light 33. The various controls mentioned above are illustrative, and any other control may be added as necessary.

### (2.3 Issues)

A spheroidal mirror including a spheroidal reflection surface may be used as the EUV light concentrating mirror 23 in the EUV light generating apparatus 1 illustrated in FIG. 1. In a case where reflectivity of such a spheroidal mirror for EUV light is measured, a light source that generates EUV light may use synchrotron radiation light, as described in J. Tummler, H. Blume, G. Brandt, J. Eden, B. Meyer, H. Scherr, F. Scholz, F. Scholze, G. Ulm, “Characterization of the PTB EUV reflectometry facility for large EUVL optical components”, Proc. SPIE 5037, 265-273 (2003). Accordingly, in order to measure the reflectivity of the spheroidal mirror at high accuracy, it may be necessary to bring the spheroidal mirror to a synchrotron installation. Moreover, in a case where synchrotron radiation light is used, it is difficult to rotate a polarization direction of the synchrotron radiation light. Accordingly, in a case where the spheroidal mirror is large, e.g. a diameter of the spheroidal mirror in a range from 400 mm to 600 mm, it may be possible to measure reflectivity of the spheroidal mirror only with light with linear polarization in one direction, due to constraints such as movement and installation.

### 3. First Embodiment

Next, description is given of a reflectivity measuring apparatus according to a first embodiment.

The present embodiment relates to an apparatus that measures, for example, reflectivity of a spheroidal mirror for EUV light such as the EUV light concentrating mirror 23 in the EUV light generating apparatus 1 illustrated in FIG. 1 with use of a coherent EUV light source.

### (3.1 Reflectivity Measuring Apparatus)

### (3.1.1 Configuration)

FIG. 2 schematically illustrates a configuration example of a reflectivity measuring apparatus according to the first embodiment of the present disclosure. The reflectivity measuring apparatus according to the present embodiment may include a coherent EUV light source 41, a beam delivery system 42, a measurement chamber 43, and a measurement controller 44.

The coherent EUV light source 41 may be an EUV light source that outputs coherent EUV light 40 toward a spheroidal mirror 50 of which reflectivity is to be measured. The coherent EUV light source 41 may be an EUV light source that outputs pulsed laser light of the EUV light 40. The pulsed laser light of the EUV light 40 may be substantially linearly polarized light with a wavelength of about 13.5 nm. A polarization direction of the linearly polarized light may be substantially perpendicular to an XZ plane in FIG. 2. In FIG. 2, a black circle in an optical path of the EUV light 40 may indicate linear polarization substantially perpendicular to the XZ plane. A second photosensor 64 illustrated in FIG. 3 to be described later may be provided in the coherent EUV light source 41. The second photosensor 64 may detect a part of the pulsed laser light of the EUV light 40 outputted from the coherent EUV light source 41.

The beam delivery system 42 may include a high reflection mirror 45, a high reflection mirror 46, and an optical path tube 47. Each of the high reflection mirror 45 and the high reflection mirror 46 may be configured of a planar substrate coated with a multilayer film of Mo/Si that reflects the EUV light 40 with a wavelength of about 13.5 nm at high reflectivity. Pressure inside the optical path tube 47 may be close to vacuum so as to allow the EUV light 40 to travel through the optical path tube 47 at high transmittance.

The measurement chamber 43 may include a cylindrical cover 51, a circular plate 52, an exhaust unit 53, a movable mirror 54, holders 55 and 56, a first rotation stage 61, a second rotation stage 62, and a first photosensor 63.

The cover 51 and the plate 52 may be sealed by an O ring 57. The exhaust unit 53 may be coupled to the cover 51 through piping so as to exhaust a gas inside the measurement chamber 43.

The spheroidal mirror 50 may be the EUV light concentrating mirror 23 in FIG. 1. The spheroidal mirror 50 may be disposed inside the measurement chamber 43. The spheroidal mirror 50 may be a concave mirror including a spheroidal reflection surface 71. The spheroidal reflection surface 71 may be a part of a spheroidal surface around a rotational symmetry axis 72. Accordingly, the spheroidal mirror 50 may include the first focal point and the second focal point. The rotational symmetry axis 72 may be substantially coincident with a Z axis. The spheroidal reflection surface 71 of the spheroidal mirror 50 may be coated with, for example, a multilayer film of Mo/Si that reflects the EUV light 40 with a wavelength of about 13.5 nm at high reflectivity.

The spheroidal mirror 50 may be fixed to the first rotation stage 61 by the holder 55 so as to allow a rotation axis of the first rotation stage 61 to be substantially coincident with the rotational symmetry axis 72 of the spheroidal mirror 50. Moreover, the first rotation stage 61 may be fixed to the plate 52. The first rotation stage 61 may rotate the spheroidal mirror 50 around the rotational symmetry axis 72 of the spheroidal mirror 50 with respect to the plate 52. The first focal point and the second focal point of the spheroidal mirror 50 disposed in the measurement chamber 43 may be a first focal position 73 and a second focal position 74, respectively.

The high reflection mirror 46 of the beam delivery system 42 may be so disposed as to allow the pulsed laser light of the EUV light 40 to travel to a reflection surface of the movable mirror 54 at the first focal position 73 of the spheroidal mirror 50.

The beam delivery system 42 and the movable mirror 54 may configure an optical system that allows the EUV light 40 to travel to the spheroidal reflection surface 71 via the first focal position 73 of the spheroidal mirror 50.

The reflection surface of the movable mirror 54 may be so disposed as to include a predetermined axis and reflect the EUV light 40. The predetermined axis may be substantially perpendicular to the rotational symmetry axis 72 of the spheroidal mirror 50 and intersect the rotational symmetry axis 72 at the first focal position 73. Hence, the first focal position 73 may be located on the reflection surface of the movable mirror 54. Herein, the predetermined axis may be an axis parallel to a Y axis. The movable mirror 54 may be configured of a planar substrate coated with, for example, a multilayer film of Mo/Si that reflects the EUV light 40 with a wavelength of about 13.5 nm at high reflectivity.

The movable mirror 54 may be fixed to the second rotation stage 62 by the holder 56. The second rotation stage 62 may rotate the movable mirror 54 around the predetermined axis mentioned above. The second rotation stage 62 may be operable to rotate the movable mirror 54 to an angular position at which the movable mirror 54 is allowed to reflect, directly to the first photosensor 63, the EUV light 40 having traveled to the movable mirror 54 from the coherent EUV light source 41.

The first photosensor 63 may be disposed so that a light reception surface of the first photosensor 63 is located at the second focal position 74 of the spheroidal mirror 50. The first photosensor 63 may be, for example, a photomultiplier having sensitivity to the EUV light 40. The first photosensor 63 may detect the EUV light 40 that has passed through the first focal position 73 and then has been reflected by the spheroidal reflection surface 71. Moreover, the first photosensor 63 may detect the EUV light 40 that has been directly reflected by the movable mirror 54 without being reflected by the spheroidal reflection surface 71.

A signal line may be coupled to the measurement controller 44. The signal line may transmit a control signal to each of the coherent EUV light source 41, the exhaust unit 53, the first rotation stage 61, and the second rotation stage 62. Moreover, a signal line that receives a signal from each of the first photosensor 63 and the coherent EUV light source 41 may be coupled to the measurement controller 44.

The measurement controller 44 may control a rotation angle of the first rotation stage 61 and an rotation angle of the second rotation stage 62, and may measure reflectivity of the spheroidal reflection surface 71 at a plurality of locations on the spheroidal reflection surface 71 on the basis of a detection result derived from the first photosensor 63.

Herein, an angle α may be an angle between the rotational symmetry axis 72 of the spheroidal mirror 50 and an optical path of the pulsed laser light of the EUV light 40 reflected by the movable mirror 54. An angle β may be the rotation angle of the first rotation stage 61.

### (3.1.2 Operation)

The spheroidal mirror 50 of which the reflectivity is to be measured may be fixed onto the first rotation stage 61 by the holder 55. Thereafter, the cover 51 and the plate 52 may be sealed by the O ring 57.

The measurement controller 44 may control the exhaust unit 53 so as to cause pressure inside the measurement chamber 43 to be a pressure at which the EUV light 40 travels through the measurement chamber 43 at high transmittance. The measurement controller 44 may transmit control data of light source parameters to the coherent EUV light source 41 so as to allow desired pulsed laser light of the EUV light 40 to be outputted. The light source parameters may include target pulse energy Et_{EUV} of the pulsed laser light of the EUV light 40, a pulse repetition frequency f, etc. The light source parameters may further include a polarization direction Po, data of an oscillation wavelength, etc. The measurement controller 44 may start oscillation of the coherent EUV light source 41 to output the pulsed laser light of the EUV light 40 from the coherent EUV light source 41.

Subsequently, the measurement controller 44 may control the second rotation stage 62 so as to change the angle α to α=180°, thereby allowing reflected light from the movable mirror 54 to directly travel to the light reception surface of the first photosensor 63. The pulsed laser light of the EUV light 40, outputted from the coherent EUV light source 41, in a polarization direction substantially perpendicular to the XZ plane may travel to the reflection surface of the movable mirror 54 at the first focal position 73 of the spheroidal mirror 50 via the high reflection mirrors 45 and 46. The reflected light from the movable mirror 54 may be the pulsed laser light of the EUV light 40 having passed through the first focal position 73 on the reflection surface of the movable mirror 54. At this occasion, the pulsed laser light of the EUV light 40 may travel to the reflection surface of the movable mirror 54 with, for example, S-polarization and then may be reflected with S-polarization by the reflection surface of the movable mirror 54 to directly travel to the light reception surface of the first photosensor 63 without being reflected by the spheroidal mirror 50.

At this occasion, the measurement controller 44 may receive a detection value that indicates a received light amount E1 and is derived from the first photosensor 63 and a detection value that indicates a received light amount E2 and is derived from the second photosensor 64 illustrated in FIG. 3 to be described later. The measurement controller 44 may calculate K=E1/E2, and may store a result of the calculation as a conversion factor K of an incident light amount Ei in an unillustrated storage section.

Subsequently, the measurement controller 44 may control the first rotation stage 61 and the second rotation stage 62 so as to allow the pulsed laser light of the EUV light 40 to travel to a desired measurement location on the spheroidal reflection surface 71 of the spheroidal mirror 50 (step 1). The measurement location on the spheroidal reflection surface 71 may be determined by a combination of the angle α and the angle β. The measurement controller 44 may control the second rotation stage 62 so as to change an angle between the rotational symmetry axis 72 of the spheroidal mirror 50 and an optical path axis of reflected light from the movable mirror 54 to a desired angle α. Moreover, the measurement controller 44 may control the first rotation stage 61 so as to change the rotation angle of the spheroidal mirror 50 around the rotational symmetry axis 72 to a desired angle β.

Accordingly, the pulsed laser light of the EUV light 40 reflected by the movable mirror 54 may travel to the spheroidal reflection surface 71 of the spheroidal mirror 50 with, for example, S-polarization. At this occasion, the reflected light from the movable mirror 54 may be the pulsed laser light of the EUV light 40 having passed through the first focal position 73. Thereafter, the pulsed laser light of the EUV light 40 may be reflected by the spheroidal reflection surface 71 of the spheroidal mirror 50 with, for example, S-polarization to travel to the light reception surface of the first photosensor 63 with, for example, S-polarization. The measurement controller 44 may receive a detection value that indicates a received light amount E1′ and is derived from the first photosensor 63 at this occasion and the detection value that indicates the received light amount E2 and is derived from the second photosensor 64 illustrated in FIG. 3 to be described later (step 2).

Thereafter, the incident light amount Ei to the spheroidal mirror 50 may be calculated by an expression Ei=K·E2. The received light amount E1′ derived from the first photosensor 63 at this occasion may be regarded as a reflected light amount Eo=E1′ from the spheroidal mirror 50. The measurement controller 44 may calculate reflectivity R at the desired measurement location on the spheroidal reflection surface 71 of the spheroidal mirror 50 by an expression R=Eo/Ei (step 3).

The measurement controller 44 may repeat the steps 1 to 3 mentioned above while changing the location to which the pulsed laser light of the EUV light 40 travels on the spheroidal reflection surface 71 of the spheroidal mirror 50, thereby measuring reflectivity at a plurality of locations on the spheroidal reflection surface 71 of the spheroidal mirror 50.

### (3.1.3 Workings)

According to the reflectivity measuring apparatus of the present embodiment, the pulsed laser light of the EUV light 40 outputted from the coherent EUV light source 41 may travel to the spheroidal reflection surface 71 of the spheroidal mirror 50 at the desired angle α from the first focal position 73 of the spheroidal mirror 50 and then may be reflected by the spheroidal reflection surface 71 of the spheroidal mirror 50. The pulsed laser light of the EUV light 40 reflected by the spheroidal reflection surface 71 of the spheroidal mirror 50 may be detected by the first photosensor 63 located around the second focal position 74 to measure reflectivity at a plurality of locations on the spheroidal reflection surface 71. Moreover, reflectivity may be measured while rotating the spheroidal mirror 50 by the desired angle β around the rotational symmetry axis 72, thereby measuring a planar distribution of reflectivity on the spheroidal reflection surface 71. This makes it possible to create a reflectivity map on the spheroidal reflection surface 71.

### (3.1.4 Modification Examples)

The foregoing embodiment involves an example in which the pulsed laser light of the EUV light 40 travels to the spheroidal reflection surface 71 of the spheroidal mirror 50 with, for example, S-polarization; however, the foregoing embodiment is not limited thereto. For example, reflectivity in a case where the pulsed laser light of the EUV light 40 travels to the spheroidal reflection surface 71 of the spheroidal mirror 50 with P-polarization may be measured. In this case, a reflectivity distribution with P-polarization may be measured.

Moreover, when the spheroidal mirror 50 is replaced for measurement, the plate 52 may be moved to a −Z direction from the cover 51 to remove the spheroidal mirror 50. At this occasion, atmospheric air may be intruded into the inside of the measurement chamber 43 and the beam delivery system 42; therefore, for example, a gate valve may be provided in a portion of the optical path tube 47 between the high reflection mirror 46 and the cover 51. Upon replacement of the spheroidal mirror 50, the gate valve may be closed, and thereafter the spheroidal mirror 50 that is a next measurement target may be disposed in the measurement chamber 43. Subsequently, the gate valve may be opened after the pressure inside the measurement chamber 43 is reduced to a near-vacuum state by the exhaust unit 53.

Further, the foregoing embodiment involves an example in which reflectivity of the spheroidal mirror 50 for EUV light with a wavelength of about 13.5 nm is measured; however, the present embodiment may be also applicable to a case where reflectivity of a spheroidal mirror for any other EUV light, e.g. EUV light with a wavelength of about 6.7 nm is measured.

### (3.2 Coherent EUV Light Source)

### (3.2.1 Configuration)

FIG. 3 schematically illustrates a configuration example of the coherent EUV light source 41 in the reflectivity measuring apparatus illustrated in FIG. 2.

The coherent EUV light source 41 may include a femtosecond laser unit 80, a noble gas chamber 81, a noble gas feeder 82, an optical path tube 83, an exhaust unit 84, a filter section 85, a power monitor 86, and a coherent EUV light source controller 48.

The femtosecond laser unit 80 may be configured to output pumping pulsed laser light with a pulse width in femtosecond (fs) toward the noble gas chamber 81. The pumping pulsed laser light may allow a noble gas to be excited. The femtosecond laser unit 80 may be titanium-sapphire laser unit that outputs substantially linearly polarized pumping pulsed laser light with a central wavelength of about 796.5 nm, a pulse width of about 5 fs to about 40 fs, pulse energy of about 4 mJ to about 10 mJ, and a pulse repetition frequency of about 1000 Hz.

The noble gas chamber 81 may contain a noble gas, and may include a window 87, a light concentrating optical system 88, a first pinhole 91, and a pressure sensor 90. The noble gas feeder 82 may be coupled to the noble gas chamber 81 through piping. The noble gas feeder 82 may include, for example, a He gas cylinder that feeds a He gas as a noble gas and a pressure control valve disposed in gas piping. The noble gas feeder 82 may feed the He gas to the noble gas chamber 81 so that pressure inside the noble gas chamber 81 becomes about 17 kPa.

The window 87 may be, for example, a MgF₂ crystal, and may be so disposed as to allow an optical axis and an axis of the pumping pulsed laser light to be substantially coincident with each other. The window 87 may be sealed to the noble gas chamber 81 by an unillustrated O ring. A thickness of the window 87 may be about 1 mm.

The first pinhole 91 may be provided to the noble gas chamber 81 with an unillustrated O ring in between. The first pinhole 91 may be provided with a through hole with a diameter substantially equal to a concentrated diameter of the pumping pulsed laser light. The diameter of the first pinhole 91 may be, for example, about 100 μm.

The light concentrating optical system 88 may be a parabolic mirror to which the pumping pulsed laser light travels at an incident angle of about 45°. The light concentrating optical system 88 may be so disposed as to allow the pumping pulsed laser light to pass through the through hole of the first pinhole 91. Moreover, the light concentrating optical system 88 may be so disposed as to allow the pumping pulsed laser light to be concentrated around the front of the through hole of the first pinhole 91. The pumping pulsed laser light concentrated around the front of the through hole of the first pin hole 91 may cause excitation of the noble gas, and harmonic light including the EUV light 40 derived from a non-linear effect of the excited noble gas may be generated on the same axis as an axis of the pumping pulsed laser light.

The optical path tube 83 may be coupled to the first pin hole 91 of the noble gas chamber 81 on downstream side of an optical path of the pumping pulsed laser light through sealing by an unillustrated O ring. The exhaust unit 84 may be coupled to the optical path tube 83 so as to reduce pressure close to vacuum. The optical path tube 83 may be coupled to a chamber 89 through sealing by an unillustrated O ring.

The filter section 85 may be configured to allow the EUV light 40 included in the harmonic light derived from the non-linear effect of the excited noble gas to selectively pass through the filter section 85. The chamber 89 may be provided with an exit port 99 from which the pulsed laser light of the EUV light 40 having passed through the filter section 85 is to be outputted. The filter section 85 may include second to fifth pinholes 92 to 95 and a bandpass filter 96. Respective through holes of the second to fifth pinholes 92 to 95 and the bandpass filter 96 may be disposed in an optical path of the pulsed laser light of the EUV light 40 in this order at respective predetermined intervals. The second and third pinholes 92 and 93 may be disposed inside the optical path tube 83. The fourth and fifth pinholes 94 and 95 and the bandpass filter 96 may be disposed inside the chamber 89. Each of the through holes of the second to fifth pinholes 92 to 95 may have a diameter that allows the pulsed laser light of the EUV light 40 to pass therethrough and allows most of the pumping pulsed laser light to be blocked.

The bandpass filter 96 may be a bandpass filter that allows the EUV light 40 with a wavelength of about 13.5 nm to pass therethrough and prevents passage of light with any other wavelength, and may be a Zr thin film filter of which a Zr thin film with a thickness of several hundred nm is fixed onto a pinhole provided with a through hole.

The power monitor 86 may be disposed in the chamber 89, and may include a transfer optical system 97, a bandpass filter 98, and the second photosensor 64.

The transfer optical system 97 may be a concave mirror, and may be so disposed as to allow an image of reflected light from the bandpass filter 96 to be formed on a light reception surface of the second photosensor 64. The transfer optical system 97 may be a spherical mirror, and may include a reflection surface coated with a multilayer film of Mo/Si so as to reflect the EUV light 40 with a wavelength of about 13.5 nm at high reflectivity.

The bandpass filter 98 may be disposed in the optical path of the EUV light 40 between the transfer optical system 97 and the second photosensor 64. The bandpass filter 98 may be a bandpass filter that allows the EUV light 40 with a wavelength of about 13.5 nm to pass therethrough and prevents passage of light with any other wavelength, and may be a Zr thin film filter of which a Zr thin film with a thickness of several hundred nm is fixed onto a pinhole provided with a through hole.

The second photosensor 64 may be configured to detect a part of the EUV light 40 outputted from the coherent EUV light source 41. The second photosensor 64 may be, for example, a photomultiplier having sensitivity to the EUV light 40, as with the first photosensor 63. The second photosensor 64 may be coupled to the coherent EUV light source controller 48.

The coherent EUV light source controller 48 may be coupled to the femtosecond laser unit 80, the pressure sensor 90, the noble gas feeder 82, the exhaust unit 84, and the measurement controller 44.

### (3.2.2 Operation)

The coherent EUV light source controller 48 may receive, from the measurement controller 44, light source parameters such as the target pulse energy Et_{EUV} of the pulsed laser light of the EUV light 40, the pulse repetition frequency f, the polarization direction Po, and a central wavelength of about 796.5 nm.

The coherent EUV light source controller 48 may control the noble gas feeder 82 and the exhaust unit 84 so as to change a detection pressure derived from the pressure sensor 90 to a target pressure Pt. The target pressure Pt herein may be about 17 kPa.

The coherent EUV light source controller 48 may control the femtosecond laser unit 80 so as to output pumping pulsed laser light having the repetition frequency f and pulse energy that allows the pulse energy of the pulsed laser light of the EUV light 40 to be the target pulse energy Et_{EUV}. The pulse energy of the pumping pulsed laser light may be about 6 mJ. Accordingly, the femtosecond laser unit 80 may output substantially linearly polarized pumping pulsed laser light with a wavelength of about 796.5 nm, a pulse width of about 30 fs, a repetition frequency f=1000 Hz, and pulse energy of about 6 mJ. The direction of linear polarization may be substantially perpendicular to the XZ plane. It is to be noted that a black circle illustrated in FIG. 3 in the optical path of the pumping pulsed laser light and the EUV light 40 may indicate linear polarization substantially perpendicular to the XZ plane.

The pumping pulsed laser light may travel to the light concentrating optical system 88 via the window 87 to be concentrated within, for example, a diameter of 100 μm in front of the through hole of the first pinhole 91. High odd-order harmonic light up to about 100th-order from the non-linear effect of the noble gas serving as a medium to be pumped may be generated on the same axis as the axis of the pumping pulsed laser light. The noble gas may be a He gas. At this occasion, 59th-order harmonic light with a wavelength of about 796.5 nm of the pumping pulsed laser light may be pulsed laser light of the EUV light 40 with a wavelength of about 13.5 nm. Moreover, a polarization direction of high-order harmonic light may be substantially coincident with the polarization direction of the pumping pulsed laser light.

The pumping pulsed laser light and the odd-order harmonic light may be outputted to the inside of the optical path tube 83 via the first pinhole 91. Since the pumping pulsed laser light has a large beam divergence angle and a wavelength longer than 13.5 nm, most of the pumping pulsed laser light may be removed by the second to fifth pinholes 92 to 95. High-order harmonic light in a soft X-ray range may travel to the bandpass filter 96 via the second to fifth pinholes 92 to 95.

The pulsed laser light of the EUV light 40 with a wavelength of about 13.5 nm may pass through the bandpass filter 96. The pulsed laser light of the EUV light 40 having passed through the bandpass filter 96 may travel to the high reflection mirror 45 of the beam delivery system 42 via the exit port 99 of the chamber 89.

In contrast, an image of a part of the pulsed laser light of the EUV light 40 reflected by a surface of the bandpass filter 96 may be formed on the light reception surface of the second photosensor 64 via the bandpass filter 98 by the transfer optical system 97. Accordingly, the second photosensor 64 may detect an amount of the pulsed laser light of the EUV light 40 with a wavelength of about 13.5 nm having been reflected by the bandpass filter 96 and then having passed through the bandpass filter 98.

A detection value indicating the received light amount E2 detected by the second photosensor 64 may be proportional to pulse energy of the pulsed laser light of the EUV light 40 with a wavelength of about 13.5 nm having passed through the bandpass filter 96. The coherent EUV light source controller 48 may transmit data of the detection value indicating the received light amount E2 derived from the second photosensor 64 for each pulse to the measurement controller 44.

### (3.2.3 Modification Examples)

The foregoing embodiment involves an example in which the EUV light 40 with a wavelength of about 13.5 nm is generated; however, the foregoing embodiment is not limited thereto. For example, EUV light with a wavelength of about 6.7 nm may be generated. More specifically, a wavelength of pumping pulsed laser light to be outputted from the femtosecond laser unit 80 may be about 797.2 nm to generate high 119th-order harmonic light.

### (3.3 Specific Examples of Reflectivity Measurement)

Next, description is given of a more specific example of a reflectivity measurement control operation by the measurement controller 44 with reference to FIGS. 4 to 18.

FIG. 4 is a main flow chart illustrating an example of a flow of control by the measurement controller 44 in the present embodiment.

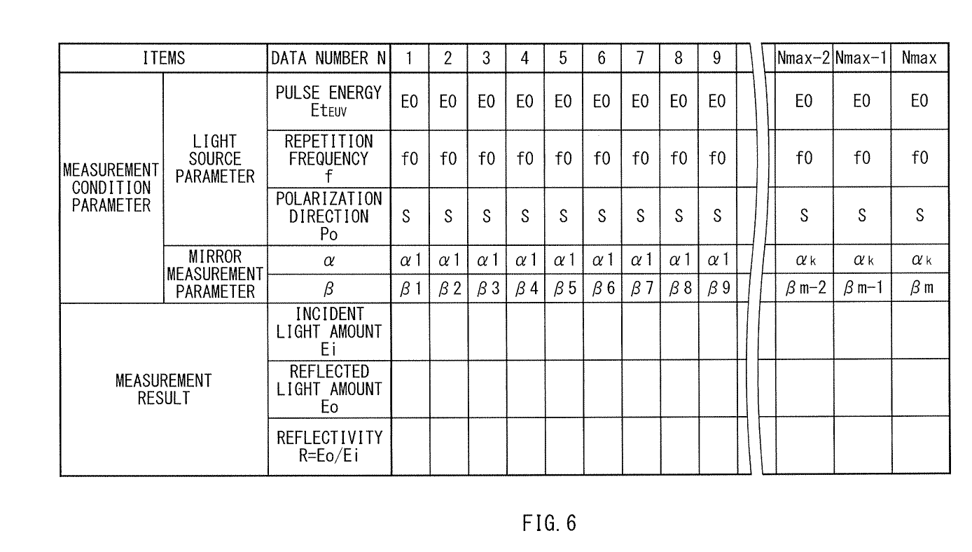

First, the measurement controller 44 may create a measurement condition parameter table (step S11). FIG. 6 illustrates an example of a table including measurement condition parameters. The measurement controller 44 may create, as the measurement condition parameter table, a table including light source parameters of the coherent EUV light source 41 and mirror measurement parameters of the spheroidal mirror 50 from a data number 1 to a data number Nmax. Subsequently, the measurement controller 44 may cause the coherent EUV light source 41 to oscillate (step S12). At this occasion, the measurement controller 44 may transmit data of the light source parameters to the coherent EUV light source 41 so as to set the light source parameters to desired light source parameters. Thus, desired pulsed laser light of the EUV light 40 may be outputted.

Subsequently, the measurement controller 44 may measure reference data (step S13). At this occasion, the measurement controller 44 may determine the reference data by calculation from a detection value when the pulsed laser light of the EUV light 40 directly travels to the first photosensor 63 without being reflected by the spheroidal reflection surface 71 of the spheroidal mirror 50 and a detection value derived from the second photosensor 64.

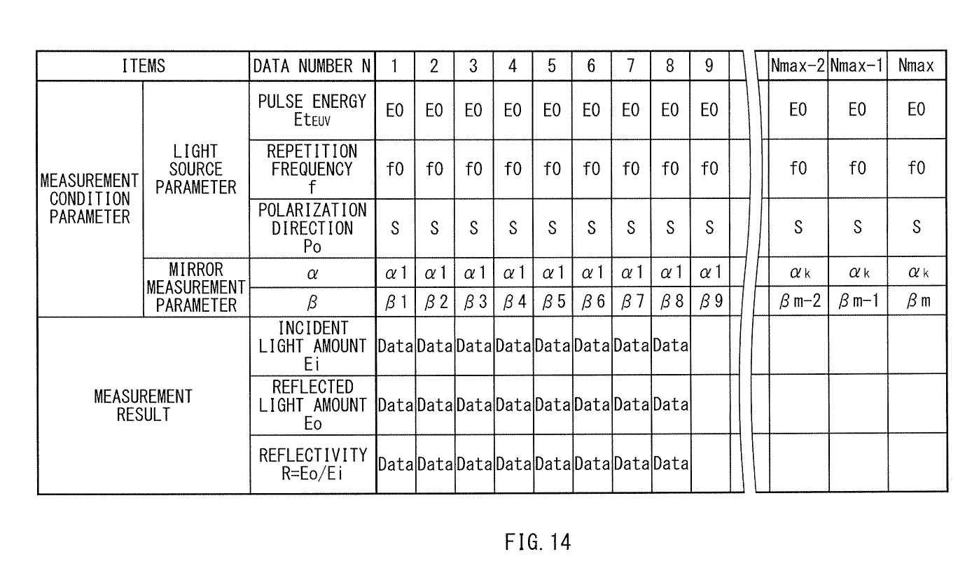

Thereafter, the measurement controller 44 may set the data number N to N=1 (step S14). Subsequently, the measurement controller 44 may set measurement conditions to measurement conditions in the data number N and perform measurement (step S15). At this occasion, the measurement conditions may be set to the mirror measurement parameters of the spheroidal mirror 50 in the data number N and read the detection value derived from the first photosensor 63 and the detection value derived from the second photosensor 64. Subsequently, the measurement controller 44 may write a measurement result and a calculation result to a table of the data number N (step S16). At this occasion, the detection value indicating the received light amount E1′ derived from the first photosensor 63 may be regarded as the reflected light amount Eo from the spheroidal mirror 50. Moreover, the incident light amount Ei may be calculated by an expression Ei=K·E2 on the basis of the detection value indicating the received light amount E2 derived from the second photosensor 64 and the conversion factor K. The reflectivity R may be determined by calculation with an expression R=Eo/Ei. FIG. 14 illustrates an example of a table including measurement results. For example, values of Eo, Ei, and R may be written as measurement results to the table, as illustrated in FIG. 14.

Subsequently, the measurement controller 44 may determine whether measurement under all conditions of the measurement condition parameters is completed (step S17), which may be determined by whether a condition of N≧Nmax is satisfied, where a maximum value of the data number N is Nmax, namely, by whether the data number N reaches the maximum value Nmax. This may determine whether measurement at all measurement locations is completed.

In a case where the measurement controller 44 determines that measurement under all conditions is not completed (step S17; N), the measurement controller 44 may set the data number N to N=N+1 (step S18), and may return to a process in the step S15.

In contrast, in a case where the measurement controller 44 determines that measurement under all conditions is completed (step S17. Y), the measurement controller 44 may transmit an oscillation stop signal to the coherent EUV light source 41 to stop oscillation of the coherent EUV light source 41 (step S19). Subsequently, the measurement controller 44 may perform a process of creating a reflectivity map where reflectivity at respective measurement locations on the spheroidal mirror 50 is mapped and displaying the reflectivity map onto an unillustrated display section (step S20), and thereafter the measurement controller 44 may end the main process. At this occasion, the measurement controller 44 may hold the created reflectivity map as data, and may store the data in an unillustrated storage medium. Alternatively, the measurement controller 44 may transmit the data to any other external unit.

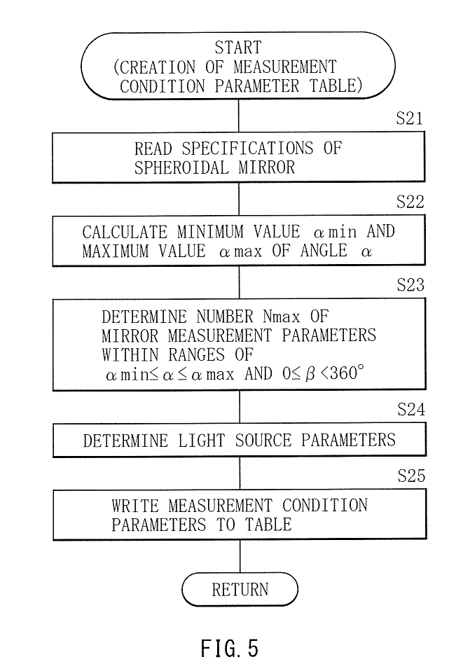

FIG. 5 is a sub-flow chart illustrating details of a process in the step S11 in the main flow chart illustrated in FIG. 4. The measurement controller 44 may perform the process illustrated in FIG. 5 as a process of creating the measurement condition parameter table.

First, the measurement controller 44 may read specifications of the spheroidal mirror 50 from an unillustrated storage section (step S21). The specifications of the spheroidal mirror 50 may be, for example, data such as the equation of a spheroid, the first focal position 73, the second focal position 74, and a range of the spheroidal reflection surface 71. Subsequently, the measurement controller 44 may calculate a minimum value αmin and a maximum value αmax of the angle α from the range of the spheroidal reflection surface 71 (step S22).

Subsequently, the measurement controller 44 may determine the number Nmax of mirror measurement parameters within ranges of αmin≦α≦αmax and 0≦β<360° (step S23). Thus, for example, combinations of the angle α and the angle β corresponding to the number Nmax of measurement locations may be determined, as illustrated in FIG. 6.

Thereafter, the measurement controller 44 may determine the light source parameters (step S24). For example, the measurement controller 44 may determine, as the light source parameters, data of the target pulse energy Et_{EUV} of the pulsed laser light of the EUV light 40, the pulse repetition frequency f, and the polarization direction Po of the EUV light 40, as illustrated in FIG. 6.

Subsequently, the measurement controller 44 may write the determined measurement condition parameters to a table in the unillustrated storage section (step S25). For example, the measurement controller 44 may write, as the measurement condition parameters, data such as the target pulse energy Et_{EUV}=E0, the repetition frequency f=f0, and the polarization direction Po=S, as illustrated in FIG. 6. Thereafter, the measurement controller 44 may return to the main flow in FIG. 4.

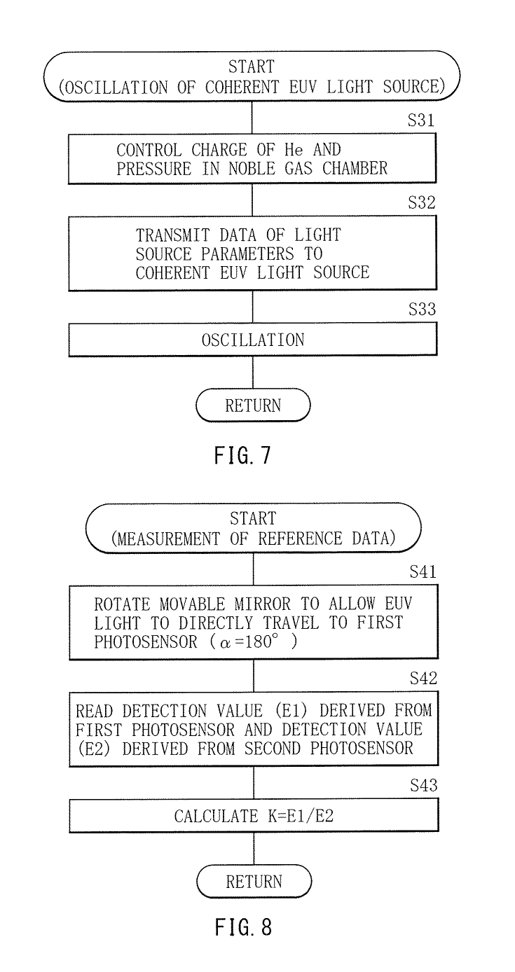

FIG. 7 is a sub-flow chart illustrating details of a process in the step S12 in the main flow chart illustrated in FIG. 4. The measurement controller 44 may perform a process illustrated in FIG. 7 as a process of causing the coherent EUV light source 41 to oscillate.

First, the measurement controller 44 may control charge of the He gas and pressure in the noble gas chamber 81 via the coherent EUV light source controller 48 (step S31). More specifically, the measurement controller 44 may control the noble gas feeder 82 and the exhaust unit 84 so as to change the detection pressure derived from the pressure sensor 90 to the target pressure Pt. The target pressure Pt may be, for example, about 17 kPa.

Subsequently, the measurement controller 44 may transmit data of the light source parameters to the coherent EUV light source 41 (step S32). For example, the measurement controller 44 may transmit, as the light source parameters, data such as the target pulse energy Et_{EUV} of the pulsed laser light of the EUV light 40 and the pulse repetition frequency f. Subsequently, the measurement controller 44 may cause the femtosecond laser unit 80 via the coherent EUV light source controller 48 to oscillate (step S33). Thereafter, the measurement controller 44 may return to the main flow in FIG. 4.

FIG. 8 is a sub-flow chart illustrating details of a process in the step S13 in the main flow chart illustrated in FIG. 4. The measurement controller 44 may perform a process illustrated in FIG. 8 as a process of measuring the reference data.

First, the measurement controller 44 may rotate the movable mirror 54 so as to allow the EUV light 40 to directly travel to the first photosensor 63 (step S41). More specifically, the measurement controller 44 may control the second rotation stage 62 to rotate the movable mirror 54, thereby changing the angle α to α=180°.

Subsequently, the measurement controller 44 may read the detection value indicating the received light amount E1 derived from the first photosensor 63 and the detection value indicating the received light amount E2 derived from the second photosensor 64 (step S42).

Subsequently, the measurement controller 44 may calculate K=E1/E2, and may store a result of the calculation as the reference data (step S43). Thus, the measurement controller 44 may estimate the incident light amount Ei to the spheroidal mirror 50 as Ei=K·E2 from the detection value indicating the received light amount E2 derived from the second photosensor 64. Thereafter, the measurement controller 44 may return to the main flow in FIG. 4.

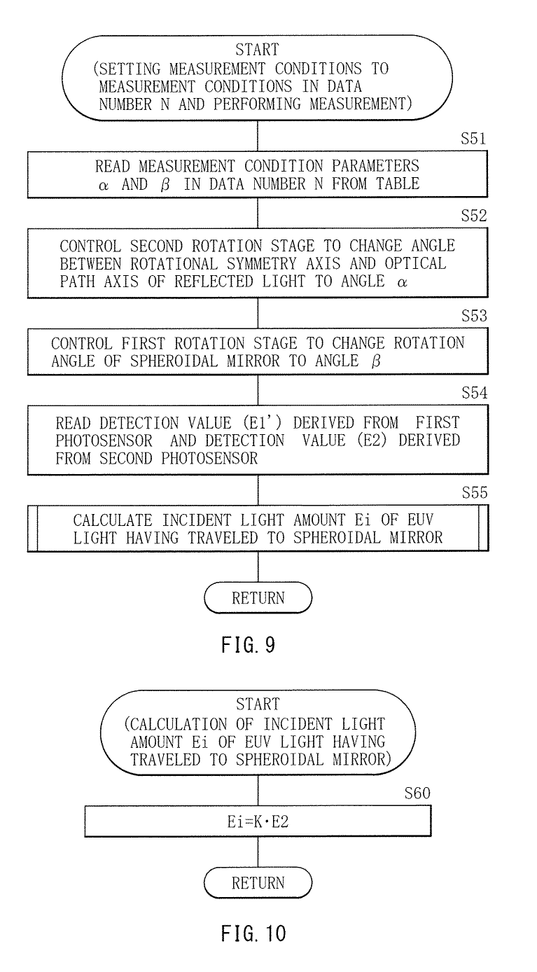

FIG. 9 is a sub-flow chart illustrating details of a process in the step S15 in the main flow chart illustrated in FIG. 4. The measurement controller 44 may perform a process illustrated in FIG. 9 as a process of setting the measurement conditions to the measurement conditions in the data number N and performing measurement.

First, the measurement controller 44 may read the angle α and the angle β as the measurement condition parameters in the data number N from the table in the unillustrated storage section (step S51).

Subsequently, the measurement controller 44 may control the second rotation stage 62 to change the angle between the rotational symmetry axis 72 of the spheroidal mirror 50 and the optical path axis of reflected light from the movable mirror 54 to the angle α (step S52). Thereafter, the measurement controller 44 may control the first rotation stage 61 so as to change the rotation angle of the spheroidal mirror 50 around the rotational symmetry axis 72 to the angle β (step S53).

Subsequently, the measurement controller 44 may read the detection value indicating the received light amount E1′ derived from the first photosensor 63 and the detection value indicating the received light amount E2 derived from the second photosensor 64 (step S54).

Subsequently, the measurement controller 44 may calculate the incident light amount Ei of the EUV light 40 having traveled to the spheroidal reflection surface 71 of the spheroidal mirror 50 (step S55). Thereafter, the measurement controller 44 may return to the main flow in FIG. 4.

FIG. 10 is a sub-flow chart illustrating a specific example of a process in the step S55 in the sub-flow chart illustrated in FIG. 9. The measurement controller 44 may perform a process illustrated in FIG. 10 as a process of calculating the incident light amount Ei of the EUV light 40 having traveled to the spheroidal reflection surface 71 of the spheroidal mirror 50.

The measurement controller 44 may determine the incident light amount Ei of the EUV light 40 having traveled to the spheroidal reflection surface 71 of the spheroidal mirror 50 by calculation with an expression Ei=K·E2 (step S60). Thereafter, the measurement controller 44 may return to the main flow in FIG. 4.

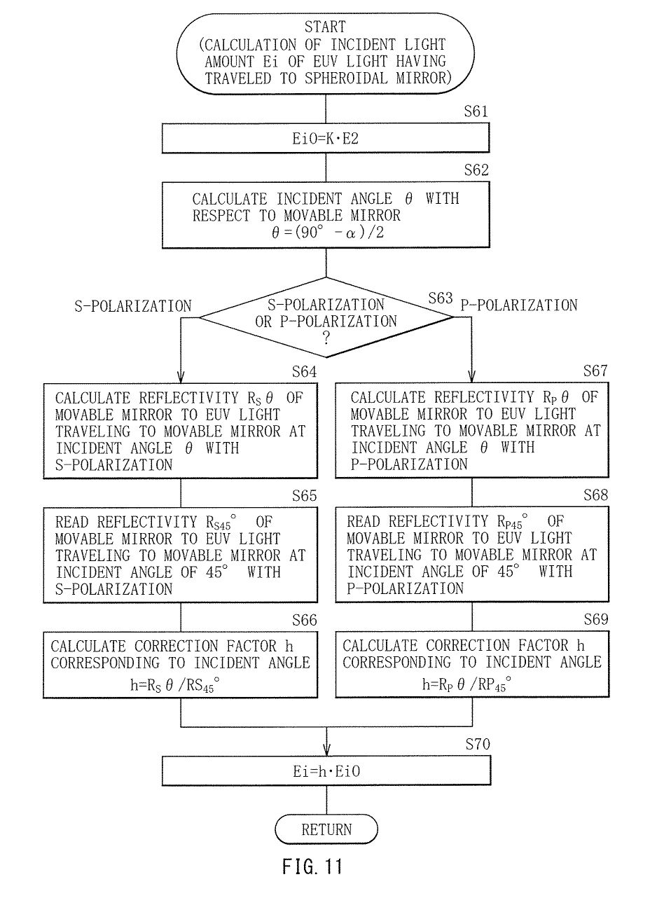

In a case where variation in reflectivity is small with respect to the incident angle θ (=(90°−α)/2) of the EUV light 40 with respect to the movable mirror 54, the incident light amount Ei may approximate to Ei=K·E2. However, in a case where variation in reflectivity is large with respect to the incident angle θ, the following process illustrated in FIG. 11 may be performed.

FIG. 11 is a sub-flow chart illustrating another specific example of the process in the step S55 in the sub-flow chart illustrated in FIG. 9.

First, the measurement controller 44 may determine an incident light amount Ei0 of the EUV light 40 having traveled to the movable mirror 54 at an incident angle θ of 45° by calculation with an expression Ei0=K·E2 (step S61).

Subsequently, the measurement controller 44 may determine the incident angle θ with respect to the movable mirror 54 by calculation with an expression θ=(90°−α)/2 (step S62).

Thereafter, the measurement controller 44 may determine whether the polarization direction of the EUV light 40 is an S-polarization direction or a P-polarization direction with respect to the reflection surface of the movable mirror 54 (step S63).

In a case where the measurement controller 44 determines that the polarization direction is the S-polarization direction, the measurement controller 44 may calculate reflectivity R_{S}θ of the movable mirror 54 to the EUV light 40 traveling to the movable mirror 54 at the incident angle θ with S-polarization (step S64). In this case, a function of the reflectivity R_{S}θ with respect to the incident angle θ of the EUV light 40 with S-polarization may be determined in advance and be stored in the unillustrated storage section, and the reflectivity R_{S}θ may be calculated from the function. Subsequently, the measurement controller 44 may read, from the unillustrated storage section, a value of the reflectivity R_{S45}° of the movable mirror 54 to the EUV light 40 traveling to the movable mirror 54 at an incident angle of 45° with S-polarization (step S65). The value of the reflectivity R_{S45}° may be stored in the unillustrated storage section in advance. Subsequently, the measurement controller 44 may determine a correction factor h corresponding to the incident angle θ of the EUV light 40 with S-polarization by calculation with an expression h=R_{S}θ/R_{S45}° (step S66). Subsequently, the measurement controller 44 may determine the incident light amount Ei of the EUV light 40 with S-polarization by calculation with an expression Ei=h·Ei0 (step S70). Thereafter, the measurement controller 44 may return to the main flow in FIG. 4.

In contrast, in case where the measurement controller 44 determines that the polarization direction is the P-polarization direction, the measurement controller 44 may calculate reflectivity R_{P}θ of the movable mirror 54 to the EUV light 40 traveling to the movable mirror 54 at the incident angle θ with P-polarization (step S67). In this case, a function of the reflectivity R_{P}θ with respect to the incident angle θ of the EUV light 40 with P-polarization may be determined in advance and be stored in the unillustrated storage section, and the reflectivity R_{P}θ may be calculated from the function. Subsequently, the measurement controller 44 may read, from the unillustrated storage section, a value of reflectivity R_{P45}° of the movable mirror 54 to the EUV light 40 traveling to the movable mirror 54 at an incident angle of 45° with P-polarization (step S68). The value of reflectivity R_{P45}° may be stored in the unillustrated storage section in advance. Subsequently, the measurement controller 44 may determine the correction factor h corresponding to the incident angle θ of the EUV light 40 with P-polarization by calculation with an expression h=R_{P}θ/R_{P45}° (step S69). Subsequently, the measurement controller 44 may determine the incident light amount Ei of the EUV light 40 with P-polarization by calculation with an expression Ei=h·Ei0 (step S70). Thereafter, the measurement controller 44 may return to the main flow in FIG. 4.

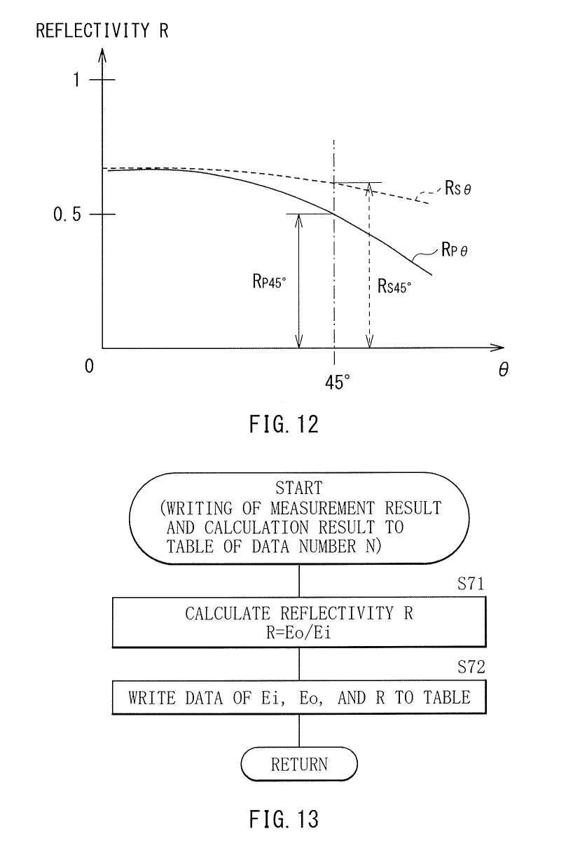

FIG. 12 schematically illustrates an example of a relationship between the incident angle θ of the EUV light 40 with respect to the movable mirror 54 and the reflectivity R. In FIG. 12, a horizontal axis may indicate the incident angle θ, and a vertical axis may indicate the reflectivity R. The function of reflectivity R_{P}θ with respect to the incident angle θ of the EUV light 40 with P-polarization and the function of reflectivity R_{S}θ with respect to the incident angle θ of the EUV light 40 with S-polarization as illustrated in FIG. 12 may be determined in advance. The function of the reflectivity R_{P}θ and the function of the reflectivity R_{S}θ may be determined by calculation from a theoretical value or may be determined by an actually measured value derived from measurement.

FIG. 13 is a sub-flow chart illustrating details of a process in the step S16 in the main flow chart illustrated in FIG. 4. The measurement controller 44 may perform a process illustrated in FIG. 13 as a process of writing the measurement result and the calculation result to the table of the data number N.

First, the measurement controller 44 may determine the reflectivity R under measurement conditions in the data number N by calculation with an expression R=Eo/Ei (step S71). Subsequently, the measurement controller 44 may write data of the incident light amount Ei, the reflected light amount Eo, and the reflectivity R as measurement results in the data number N to the table in the unillustrated storage section (step S72). It is to be noted that FIG. 14 schematically illustrates an example of the table to which the measurement results are written. Thereafter, the measurement controller 44 may return to the main flow in FIG. 4.

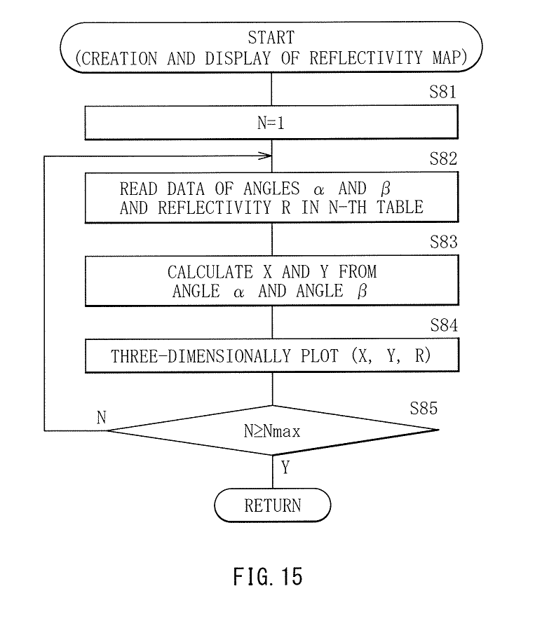

FIG. 15 is a sub-flow chart illustrating details of a process in step S20 in the main flow chart illustrated in FIG. 4. The measurement controller 44 may perform a process illustrated in FIG. 15 as a process of creating and displaying the reflectivity map.

First, the measurement controller 44 may set the data number N to N=1 (step S81). Subsequently, the measurement controller 44 may read data of the angles α and β and the reflectivity R in an N-th table (step S82). Subsequently, the measurement controller 44 may calculate coordinate points X and Y from the angle α and the angle β (step S83).

The coordinate points X and Y herein may be calculated as follows.

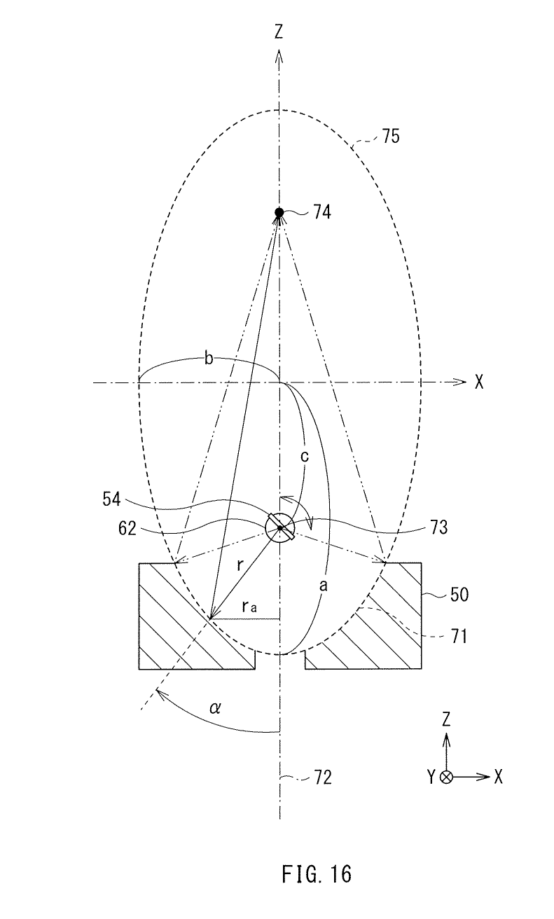

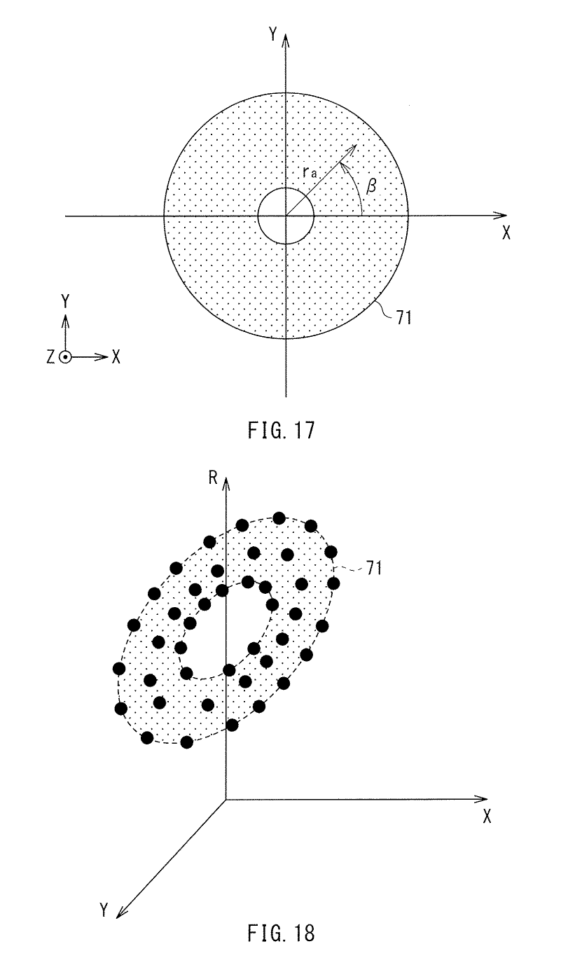

FIG. 16 schematically illustrates an equation representing an elliptical shape. FIG. 17 schematically illustrates parameters used to create the reflectivity map. The spheroidal reflection surface 71 may be a part of a spheroidal surface 75 around the Z axis, as illustrated in FIG. 16. Herein, the following expression may be established by an ellipse equation.

r=a(1−ε·cos α),ε=c/a

where “a” may be a radius in a long axis direction of an ellipse, “b” may be a radius in a short axis direction of the ellipse, “c” may be a distance from a center of the ellipse to the first focal position 73, and “r” may be a distance from the first focal position 73 to any ellipse position.

The following expression may be established, where “rₐ” is a distance from the Z axis in a plane substantially perpendicular to the Z axis and including measurement locations as illustrated in FIGS. 16 and 17.

rₐ=r·sin α

Accordingly, X and Y may be represented by the following expressions as coordinate points in an XY plane substantially perpendicular to the Z axis.

X=rₐ·cos β,

Y=rₐ·sin β

The measurement controller 44 may three-dimensionally plot the values of the coordinate points X and Y and the reflectivity R determined as described above as three-dimensional coordinates (X, Y, R), and may display the three-dimensional coordinates (X, Y, R) on the unillustrated display section (step S84). FIG. 18 schematically illustrates an example of the displayed reflectivity map in which the values are three-dimensionally plotted. In FIG. 18, a plurality of black circles may be three-dimensionally plotted coordinate points.

Subsequently, the measurement controller 44 may determine whether N≧Nmax is satisfied, namely, whether the data number N reaches the maximum value Nmax (step S85). In a case where the measurement controller 44 determines that N≧Nmax is not satisfied (step S85; N), the measurement controller 44 may return to the process in step S82. In a case where the measurement controller 44 determines that N≧Nmax is satisfied (step S85; Y), the measurement controller 44 may return to the main flow in FIG. 4, and may end the process.

### 4. Second Embodiment

Next, description is given of a reflectivity measuring apparatus according to a second embodiment of the present disclosure. Note that substantially same components as the components of the reflectivity measuring apparatus according to the foregoing first embodiment are denoted by same reference numerals, and redundant description thereof is omitted.

### (4.1 Configuration)

FIG. 19 schematically illustrates a configuration example of a coherent EUV light source 41A in the reflectivity measuring apparatus according to the second embodiment of the present disclosure. In the present embodiment, the entirety of a configuration of the reflectivity measuring apparatus may be substantially similar to that of the reflectivity measuring apparatus in FIG. 2.

The coherent EUV light source 41A in the present embodiment may further include a polarization varying section in the coherent EUV light source 41 illustrated in FIG. 3. The polarization varying section may selectively vary the polarization direction of the EUV light 40. The polarization direction varying section may vary the polarization direction so as to allow the EUV light 40 to travel to the spheroidal reflection surface 71 of the spheroidal mirror 50 with linear-polarization in one of a first polarization direction and a second polarization that are different from each other.

The first polarization direction and the second polarization direction may be, for example, a linear P-polarization direction and a linear S-polarization direction with respect to the spheroidal reflection surface 71, respectively.

The coherent EUV light source 41A may include a λ/2 plate 110 and an automatic rotation stage-equipped holder 111 as the polarization direction varying section. The λ/2 plate 110 may be disposed in an optical path between the window 87 and the light concentrating optical system 88. The Δ/2 plate 110 may be an MgF₂ substrate. The λ/2 plate 110 may be fixed to the automatic rotation stage-equipped holder 111.

The automatic rotation stage-equipped holder 111 may have an opening through which pumping pulsed laser light from the femtosecond laser unit 80 passes. The automatic rotation stage-equipped holder 111 may be configured to change an angle γ between an optical axis of the λ/2 plate 110 and the polarization direction of the pumping pulsed laser light from the femtosecond laser unit 80 to 0° and 45°. Rotation of a rotation stage of the automatic rotation stage-equipped holder 111 may be controlled by the measurement controller 44 and the coherent EUV light source controller 48.

It is to be noted that in FIG. 19, a black circle in the optical path of the pumping pulsed laser light and the EUV light 40 may indicate linear polarization substantially perpendicular to the XZ plane. An arrow illustrated to be substantially perpendicular to the optical path of the pumping pulsed laser light and the EUV light 40 may indicate linear polarization in the direction including the XZ plane.

Other configurations may be substantially similar to those of the coherent EUV light source 41 illustrated in FIG. 3.

### (4.2 Operation)

First, the coherent EUV light source controller 48 may receive a signal that triggers measurement with P-polarization from the measurement controller 44. Subsequently, the coherent EUV light source controller 48 may control the rotation stage of the automatic rotation stage-equipped holder 111 so as to change the angle γ between the optical axis of the λ/2 plate 110 and the polarization direction of the pumping pulsed laser light to substantially 45°. Accordingly, the pumping pulsed laser light outputted from the femtosecond laser unit 80 may pass through the λ/2 plate 110, and the polarization direction of the pumping pulsed laser light may be thereby rotated by 90° to the direction including the XZ plane. As a result, the polarization direction of the pulsed laser light of the EUV light 40 may be also changed to the direction including the XZ plane.

The pulsed laser light of the EUV light 40 outputted from the coherent EUV light source 41A may travel to the reflection surface of the movable mirror 54 via the high reflection mirror 45 and the high reflection mirror 46 with P-polarization, and may travel to the spheroidal reflection surface 71 of the spheroidal mirror 50 with P-polarization. Light reflected by the spheroidal reflection surface 71 of the spheroidal mirror 50 may travel to the light reception surface of the first photosensor 63.

The measurement controller 44 may perform control substantially similar to the control in the foregoing first embodiment to measure reflectivity with P-polarization at a plurality of measurement locations on the spheroidal reflection surface 71 of the spheroidal mirror 50.

Subsequently, the coherent EUV light source controller 48 may receive a signal that triggers measurement with S-polarization from the measurement controller 44. Subsequently, the coherent EUV light source controller 48 may control the rotation stage of the automatic rotation stage-equipped holder 111 so as to change the angle γ between the optical axis of the λ/2 plate 110 and the polarization direction of the pumping pulsed laser light to 0°. Accordingly, even though the pumping pulsed laser light has passed through the λ/2 plate 110, the polarization direction of the pumping pulsed laser light outputted from the femtosecond laser unit 80 may not be rotated, thereby being returned to the polarization direction substantially perpendicular to the XZ plane.

The measurement controller 44 may perform control substantially similar to the control in the foregoing first embodiment to measure reflectivity with S-polarization at a plurality of measurement locations on the spheroidal reflection surface 71 of the spheroidal mirror 50. The plurality of measurement locations may be substantially similar to the locations where measurement with P-polarization is performed.

After completion of measurement of the reflectivity with S-polarization, the measurement controller 44 may calculate reflectivity Rt with non-polarization from reflectivity Rs of the spheroidal mirror 50 with S-polarization and reflectivity Rp of the spheroidal mirror 50 with P-polarization at each of the measurement locations. The measurement controller 44 may calculate the reflectivity Rt with non-polarization by an expression Rt=(Rs+Rp)/2. The measurement controller 44 may display the reflectivity Rt with non-polarization at a desired measurement location as a reflectivity map, as illustrated in FIG. 18.

Other operations may be substantially similar to those in the reflectivity measuring apparatus illustrated in FIG. 2 and the coherent EUV light source 41 illustrated in FIG. 3.

### (4.3 Workings)

According to the reflectivity measuring apparatus using the coherent EUV light source 41A of the present embodiment, the polarization direction of the pulsed laser light of the EUV light 40 outputted from the coherent EUV light source 41A may be varied by 90°. Accordingly, the pulsed laser light of the EUV light 40 may selectively travel to the spheroidal reflection surface 71 of the spheroidal mirror 50 with S-polarization and P-polarization. Thus, the reflectivity Rs with S-polarization and the reflectivity Rp with P-polarization may be measured. As a result, the reflectivity Rt with non-polarization in an actual EUV light source may be measured from an average value of the reflectivity Rs with S-polarization and the reflectivity Rp with P-polarization.

Other workings may be substantially similar to those in the reflectivity measuring apparatus illustrated in FIG. 2 and the coherent EUV light source 41 illustrated in FIG. 3.

### (4.4 Modification Examples)

The present embodiment involves a case where the λ/1 plate 110 controls the polarization direction of the pumping pulsed laser light outputted from the femtosecond laser unit 80; however, the present embodiment is not limited thereto. For example, the polarization direction of the pumping pulsed laser light outputted from the femtosecond laser unit 80 may be controlled by rotating a plurality of mirrors. Moreover, the polarization direction of the pumping pulsed laser light may not be rotated, but a polarization direction of the pulsed laser light of the EUV light 40 converted from the pumping pulsed laser light may be rotated.

### 5. Third Embodiment

Next, description is given of a reflectivity measuring apparatus according to a third embodiment of the present disclosure. Note that substantially same components as the components of the reflectivity measuring apparatus according to any of the foregoing first and second embodiments are denoted by same reference numerals, and redundant description thereof is omitted.

### (5.1 Configuration)

FIG. 20 schematically illustrates a configuration example of a coherent EUV light source 41B in the reflectivity measuring apparatus according to the third embodiment of the present disclosure. In the present embodiment, the entirety of a configuration of the reflectivity measuring apparatus may be substantially similar to that of the reflectivity measuring apparatus in FIG. 2.

The coherent EUV light source 41B in the present embodiment may include a spectrometer 112 in place of the second photosensor 64 in the coherent EUV light source 41A illustrated in FIG. 19. It is to be noted that the coherent EUV light source 41B may include the spectrometer 112 in place of the second photosensor 64 in the coherent EUV light source 41 illustrated in FIG. 3. The spectrometer 112 may have a configuration illustrated in FIG. 23 to be described later.

The coherent EUV light source 41B may include a wavelength adjuster that varies a central wavelength λm of oscillation of the EUV light 40. The wavelength adjuster may be achieved by the femtosecond laser unit 80 having a configuration illustrated in FIG. 22 to be described later.

The coherent EUV light source controller 48 may receive a detection value corresponding to the central wavelength λm of oscillation and a detection value corresponding to the received light amount E2 from the spectrometer 112. The detection value corresponding to the central wavelength λm of oscillation may be a value indicating a position of a diffraction image 174 illustrated in FIG. 23 to be described later. The detection value corresponding to the received light amount E2 may be a value indicating an integrated light amount of the diffraction image 174 illustrated in FIG. 23 to be described later. The coherent EUV light source controller 48 may be coupled to a signal line that receives the detection value corresponding to the central wavelength km of oscillation and the detection value corresponding to the received light amount E2 from the spectrometer 112. Moreover, the coherent EUV light source controller 48 may be coupled to a signal line that transmits a signal Δλ that controls a central wavelength of oscillation of the femtosecond laser unit 80.

Other configurations may be substantially similar to those in the reflectivity measuring apparatus illustrated in FIG. 2, the coherent EUV light source 41A illustrated in FIG. 19, or the coherent EUV light source 41 illustrated in FIG. 3.

### (5.2 Operation)

The coherent EUV light source controller 48 may control the femtosecond laser unit 80 so as to cause the femtosecond laser unit 80 to output pumping pulsed laser light upon reception of data of a target oscillation wavelength λt from the measurement controller 44. As a result, a part of pulsed laser light of the EUV light 40 may travel to the spectrometer 112.

The coherent EUV light source controller 48 may calculate the central wavelength λm of oscillation of the pulsed laser light of EUV light 40 on the basis of a detection result derived from the spectrometer 112. Moreover, the light amount of the pulsed laser light of the EUV light 40 may be calculated as the received light amount E2 on the basis of the detection result derived from the spectrometer 112.

The coherent EUV light source controller 48 may calculate a difference Δλ between the central wavelength λm of oscillation and the target wavelength λt by an expression Δλ=λm−λt. The coherent EUV light source controller 48 may control an oscillation wavelength of the femtosecond laser unit 80 so as to change the difference Δλ close to zero. In a case where a condition of |Δλ|≦λr is satisfied, i.e., in a case where an absolute value of the difference Δλ falls within a range of Δλr, the coherent EUV light source controller 48 may transmit a wavelength control completion signal to the measurement controller 44.

The measurement controller 44 may vary the target wavelength λt within a predetermined range, for example, a range from 13.0 nm to 14.0 nm by a certain rate. e.g. by 0.1 nm. The measurement controller 44 may vary a wavelength and measure reflectivity with respect to each wavelength at a desired measurement location on the spheroidal reflection surface 71 of the spheroidal mirror 50.

Other operations may be substantially similar to those in the reflectivity measuring apparatus illustrated in FIG. 2, the coherent EUV light source 41A illustrated in FIG. 19, and the coherent EUV light source 41 illustrated in FIG. 3.

### (5.3 Workings)

According to the reflectivity measuring apparatus using the coherent EUV light source 41B of the present embodiment, the wavelength of the pulsed laser light of the EUV light 40 to be outputted from the coherent EUV light source 41B may be varied. This makes it possible to measure wavelength dependence of the reflectivity of the spheroidal reflection surface 71 of the spheroidal mirror 50 at a desired measurement location, thereby measuring a peak wavelength of the reflectivity. Accordingly, it is possible to determine whether reflectivity at a wavelength of 13.5 nm is substantially coincident with reflectivity at the peak wavelength.

Other workings may be substantially similar to those in the reflectivity measuring apparatus illustrated in FIG. 2, the coherent EUV light source 41A illustrated in FIG. 19, or the coherent EUV light source 41 illustrated in FIG. 3.

### (5.4 Modification Examples)

The present embodiment involves an example in which the wavelength of high-order harmonic light after wavelength conversion is measured with the spectrometer 112; however, the present embodiment is not limited thereto. For example, a wavelength Δp of the pumping pulsed laser light may be measured to calculate a wavelength λ_{EUV} of the EUV light 40 by an expression λ_{EUV}=λp/59. The thus-calculated wavelength λ_{EUV} may be regarded as the central wavelength λm of oscillation of the pulsed laser light of the EUV light 40.

### 6. Variations of Filter Section

Next, description is given of variations of the filter section 85 in the coherent EUV light source.

Note that substantially same components as the components of the coherent EUV light sources 41, 41A, and 41B according to the foregoing first to third embodiments are denoted by same reference numerals, and redundant description thereof is omitted.

FIG. 21 schematically illustrates a modification example of the filter section 85 in the coherent EUV light source. The filter section 85 of any of the coherent EUV light sources 41, 41A, and 41B in the foregoing first to third embodiments may have a configuration of a filter section 85A illustrated in FIG. 21.

The filter section 85A may include first and second multilayer film mirrors 113 and 114 in place of the second to fifth pinholes 92 to 95. Each of the first and second multilayer film mirrors 113 and 114 may be a mirror configured of a multilayer film of Mo/Si that reflects the EUV light 40 with a wavelength of about 13.5 nm at high reflectivity.

The filter section 85 using the second to fifth pinholes 92 to 95 may not prevent passage of high-order harmonic light with a wavelength of about 13.5 nm other than 59th-order harmonic light in some cases. Accordingly, the first and second multilayer film mirrors 113 and 114 may be provided in the filter section 85A to repeatedly reflect high-order harmonic light between the first and second multilayer film mirrors 113 and 114, thereby preventing reflection of high-order harmonic light other than the 59th-order harmonic light. Lastly, the bandpass filter 96 may allow the EUV light 40 with a wavelength of about 13.5 nm to pass therethrough.

### 7. Femtosecond Laser Unit

Next, description is given of a specific configuration example of the femtosecond laser unit 80 in the coherent EUV light source.

### (7.1 Configuration)

FIG. 22 illustrates a specific configuration example of the femtosecond laser unit 80. The femtosecond laser unit 80 of any of the coherent EUV light sources 41, 41A, and 41B in the foregoing first to third embodiments may have a configuration illustrated in FIG. 22.

The femtosecond laser unit 80 may include a mode-locked laser 121, high reflection mirrors 122 and 123, a pulse stretcher 124, an amplifier 125, and a pulse compressor 126.

The mode-locked laser 121 may include an excitation laser unit 120, a saturable absorber mirror 131, high reflection mirrors 132A, 132B, and 132C, and a titanium-sapphire crystal 133. The mode-locked laser 121 may further include prisms 134A, 134B, 134C, and 134D, a slit 135, a uniaxial stage 136, and an output coupling mirror 137.

In the mode-locked laser 121, the saturable absorber mirror 131 and the output coupling mirror 137 may configure an optical resonator. The high reflection mirror 132A, the titanium-sapphire crystal 133, the high reflection mirrors 132B and 132C, the prisms 134A and 134B, the slit 135, and the prisms 134C and 134D may be disposed in an optical path of the optical resonator in this order. An apex angle of each of the prisms 134A, 134B, 134C, and 134D may be an angle at which a light incident angle and a light output angle each are substantially a Brewster's angle.

The prism 134A and the prism 134B may be disposed so that light is inputted to and outputted from the prism 134A and the prism 134B at the Brewster's angle in dispersion directions opposite to each other. The prism 134C and the prism 134D may be disposed so that light is inputted and outputted from the prism 134C and the prism 134D at the Brewster's angle in dispersion directions opposite to each other.

The slit 135 may include an opening disposed in an optical path between the prism 134B and the prism 134C. The slit 135 may be fixed to the unixial stage 136 by an unillustrated holder so as to be moved in a movement direction 138 indicated by an arrow illustrated in FIG. 22, e.g. a direction substantially perpendicular to an optical path axis.

The high reflection mirrors 122 and 123 may be so disposed as to allow the pulsed laser light outputted from the mode-locked laser 121 to travel to the pulse stretcher 124.

The pulse stretcher 124 may include gratings 141 and 142, light concentrating lenses 143 and 144, and high reflection mirrors 145 and 146. The gratings 141 and 142 and the light concentrating lenses 143 and 144 may be so disposed as to stretch a pulse time width of incident pulsed laser light.

The amplifier 125 may be so disposed as to amplify the pulsed laser light outputted from the pulse stretcher 124. The amplifier 125 may include a regenerative amplifier 150 including a titanium-sapphire crystal 151 and an amplifier including a titanium-sapphire crystal 152. The amplifier including the titanium-sapphire crystal 152 may include an unillustrated excitation laser unit.

The regenerative amplifier 150 may include a high reflection mirror 153, a λ/4 plate 154, an electro-optical (EO) Pockels cell 155, a polarizer 156, the titanium-sapphire crystal 151, a high reflection mirror 157, and an unillustrated excitation laser unit.

The pulse compressor 126 may include gratings 161 and 162 disposed in an optical path of the pulsed laser light outputted from the amplifier 125.

### (7.2 Operation)

In the mode-locked laser 121, mode-locked laser oscillation may occur in a wavelength region passing through the opening of the slit 135, and pulsed laser light with a pulse time width in femtosecond may be outputted from the output coupling mirror 137. The pulse stretcher 124 may stretch the pulse time width of the pulsed laser light, and the regenerative amplifier 150 may amplify the pulsed laser light at a desired repetition frequency. Thereafter, the amplifier 152 may further amplify the thus-amplified pulsed laser light.

The pulse compressor 126 may convert the pulsed laser light amplified by the amplifier 125 into pulsed laser light with a pulse time width in femtosecond again. At this occasion, the position of the opening of the slit 135 may be moved toward the movement direction 138 indicated by the arrow illustrated in FIG. 22 to vary the central wavelength of the pulsed laser light with a pulse time width in femtosecond.

Each of the coherent EUV light sources 41, 41A, and 41B in the foregoing first to third embodiments may include a wavelength adjuster that varies the central wavelength km of the EUV light 40 by using the femtosecond laser unit 80 illustrated in FIG. 22. In this case, the wavelength adjuster may include the slit 135 and the uniaxial stage 136. The coherent EUV light source controller 48 may control the uniaxial stage 136 to move the position of the opening of the spit 135, thereby varying the central wavelength λm of the EUV light 40.

### 8. Spectrometer

Next, description is given of a specific configuration example of the spectrometer 112 illustrated in FIG. 20.

### (8.1 Configuration)

FIG. 23 illustrates a specific configuration example of the spectrometer 112. FIG. 23 schematically illustrates a configuration example in a case where the spectrometer 112 is an oblique incidence spectrometer. The spectrometer 112 may include an incident slit 170, a spectrometer chamber 171, a concave grating 172, and a multichannel detector 173.

The concave grating 172 and the multichannel detector 173 may be so disposed as to allow the diffraction image 174 of first-order light of the EUV light 40 with a wavelength of about 13.5 nm having entered the incident slit 170 to be formed on a light reception surface of the multichannel detector 173.

The concave grating 172 may be spherical, and may be a grating coated with gold. The multichannel detector 173 may include an image intensifier including a multichannel plate and a phosphor screen and a one-dimensional diode array.

### (8.2 Operation)

Transmitted light 175 from the bandpass filter 98 may enter the incident slit 170. The transmitted light 175 from the bandpass filter 98 may be a part of the EUV light 40 with a wavelength of about 13.5 nm. The coherent EUV light source controller 48 may determine the central wavelength λm of oscillation of the coherent EUV light source 41B from a value indicating the position of the diffraction image 174. At this occasion, the position of the diffraction image 174 may be a position of a barycenter of the diffraction image 174 or a peak wavelength. Moreover, the coherent EUV light source controller 48 may determine the received light amount from a value indicating an integrated light amount of the diffraction image 174.

### 9. Hardware Environment of Controller

A person skilled in the art will appreciate that a general-purpose computer or a programmable controller may be combined with a program module or a software application to execute any subject matter disclosed herein. The program module, in general, may include one or more of a routine, a program, a component, a data structure, and so forth that each causes any process described in any example embodiment of the present disclosure to be executed.

FIG. 24 is a block diagram illustrating an exemplary hardware environment in which various aspects of any subject matter disclosed therein may be executed. An exemplary hardware environment 100 in FIG. 24 may include a processing unit 1000, a storage unit 1005, a user interface 1010, a parallel input/output (I/O) controller 1020, a serial I/O controller 1030, and an analog-to-digital (A/D) and digital-to-analog (D/A) converter 1040. Note that the configuration of the hardware environment 100 is not limited thereto.

The processing unit 1000 may include a central processing unit (CPU) 1001, a memory 1002, a timer 1003, and a graphics processing unit (GPU) 1004. The memory 1002 may include a random access memory (RAM) and a read only memory (ROM). The CPU 1001 may be any commercially-available processor. A dual microprocessor or any other multi-processor architecture may be used as the CPU 1001.

The components illustrated in FIG. 24 may be coupled to one another to execute any process described in any example embodiment of the present disclosure.

Upon operation, the processing unit 1000 may load programs stored in the storage unit 1005 to execute the loaded programs. The processing unit 1000 may read data from the storage unit 1005 together with the programs, and may write data in the storage unit 1005. The CPU 1001 may execute the programs loaded from the storage unit 1005. The memory 1002 may be a work area in which programs to be executed by the CPU 1001 and data to be used for operation of the CPU 1001 are held temporarily. The timer 1003 may measure time intervals to output a result of the measurement to the CPU 1001 in accordance with the execution of the programs. The GPU 1004 may process image data in accordance with the programs loaded from the storage unit 1005, and may output the processed image data to the CPU 1001.

The parallel I/O controller 1020 may be coupled to parallel I/O devices operable to perform communication with the processing unit 1000, and may control the communication performed between the processing unit 1000 and the parallel 1/O devices. Non-limiting examples of the parallel I/O devices may include the measurement controller 44 and the coherent EUV light source controller 48. The serial I/O controller 1030 may be coupled to a plurality of serial I/O devices operable to perform communication with the processing unit 1000, and may control the communication performed between the processing unit 1000 and the serial I/O devices. Non-limiting examples of serial I/O devices may include the first rotation stage 61 and the second rotation stage 62. The A/D and D/A converter 1040 may be coupled to various kinds of sensors and analog devices through respective analog ports. Non-limiting examples of the sensors may include the first photosensor 63, the second photosensor 64, and the pressure sensor 90. Non-limiting examples of the analog devices may include the noble gas feeder 82, and the exhaust unit 84. The A/D and D/A converter 1040 may control communication performed between the processing unit 1000 and the analog devices, and may perform analog-to-digital conversion and digital-to-analog conversion of contents of the communication.

The user interface 1010 may provide an operator with display showing a progress of the execution of the programs executed by the processing unit 1000, such that the operator is able to instruct the processing unit 1000 to stop execution of the programs or to execute an interruption routine.

The exemplary hardware environment 100 may be applied to one or more of configurations of the EUV light generation controller 5, the measurement controller 44, and other controllers according to any example embodiment of the present disclosure. A person skilled in the art will appreciate that such controllers may be executed in a distributed computing environment, namely, in an environment where tasks may be performed by processing units linked through any communication network. In any example embodiment of the present disclosure, controllers such as the EUV light generation controller 5 and the measurement controller 44 may be coupled to one another through a communication network such as Ethernet (Registered Trademark) or the Internet. In the distributed computing environment, the program module may be stored in each of local and remote memory storage devices.

### 10. Et Cetera

The foregoing description is intended to be merely illustrative rather than limiting. It should therefore be appreciated that variations may be made in example embodiments of the present disclosure by persons skilled in the art without departing from the scope as defined by the appended claims.

The terms used throughout the specification and the appended claims are to be construed as “open-ended” terms. For example, the term “include” and its grammatical variants are intended to be non-limiting, such that recitation of items in a list is not to the exclusion of other like items that can be substituted or added to the listed items. The term “have” and its grammatical variants are intended to be non-limiting, such that recitation of items in a list is not to the exclusion of other like items that can be substituted or added to the listed items. Also, the singular forms “a”, “an”, and “the” used in the specification and the appended claims include plural references unless expressly and unequivocally limited to one referent.

What is claimed is:

1. A spheroidal mirror reflectivity measuring apparatus for extreme ultraviolet light, the spheroidal mirror reflectivity measuring apparatus comprising:
an extreme ultraviolet light source configured to output extreme ultraviolet light to a spheroidal mirror that includes a spheroidal reflection surface;
an optical system configured to allow the extreme ultraviolet light to travel to the spheroidal reflection surface via a first focal position of the spheroidal mirror; and
a first photosensor provided at a second focal position of the spheroidal mirror, and configured to detect the extreme ultraviolet light that has passed through the first focal position and then has been reflected by the spheroidal reflection surface.

2. The spheroidal mirror reflectivity measuring apparatus according to claim 1, further comprising a first rotation stage configured to rotate the spheroidal mirror around a rotational symmetry axis of the spheroidal mirror.

3. The spheroidal mirror reflectivity measuring apparatus according to claim 1, further comprising a second rotation stage,
wherein the optical system includes a movable mirror including a reflection surface that includes a predetermined axis and reflects the extreme ultraviolet light, the predetermined axis being perpendicular to a rotational symmetry axis of the spheroidal mirror and intersecting the rotational symmetry axis at the first focal position, and
the second rotation stage is configured to rotate the movable mirror around the predetermined axis.

4. The spheroidal mirror reflectivity measuring apparatus according to claim 3, wherein the second rotation stage is operable to rotate the movable mirror to an angular position at which the movable mirror is allowed to reflect the extreme ultraviolet light, having traveled to the movable mirror from the extreme ultraviolet light source, directly to the first photosensor.

5. The spheroidal mirror reflectivity measuring apparatus according to claim 2, further comprising a second rotation stage,
wherein the optical system includes a movable mirror including a reflection surface that includes a predetermined axis and reflects the extreme ultraviolet light, the predetermined axis being perpendicular to the rotational symmetry axis of the spheroidal mirror and intersecting the rotational symmetry axis at the first focal position, and
the second rotation stage is configured to rotate the movable mirror around the predetermined axis.

6. The spheroidal mirror reflectivity measuring apparatus according to claim 5, further comprising a measurement controller configured to control rotation of the first rotation stage and rotation of the second rotation stage, and measure, on a basis of a detection result derived from the first photosensor, reflectivity of the spheroidal reflection surface at a plurality of locations on the spheroidal reflection surface.

7. The spheroidal mirror reflectivity measuring apparatus according to claim 1, further comprising a polarization direction varying section configured to selectively vary a polarization direction of the extreme ultraviolet light to allow the extreme ultraviolet light to travel to the spheroidal reflection surface with linear-polarization in one of a first polarization direction and a second polarization direction that are different from each other.

8. The spheroidal mirror reflectivity measuring apparatus according to claim 1, wherein the extreme ultraviolet light source includes a wavelength adjuster configured to vary a central wavelength of the extreme ultraviolet light.

9. The spheroidal mirror reflectivity measuring apparatus according to claim 1, further comprising a second photosensor configured to detect a part of the extreme ultraviolet light outputted from the extreme ultraviolet light source.

10. The spheroidal mirror reflectivity measuring apparatus according to claim 1, wherein the extreme ultraviolet light is coherent light.

11. The spheroidal mirror reflectivity measuring apparatus according to claim 1, wherein the extreme ultraviolet light source includes:
a noble gas chamber configured to contain a noble gas;
a femtosecond laser unit configured to output pumping laser light with a pulse width in femtosecond to the noble gas chamber, the pumping laser light allowing the noble gas to be excited; and
a filter section configured to allow the extreme ultraviolet light included in harmonic light to selectively pass through the filter section, the harmonic light being derived from a non-linear effect of the excited noble gas.
